(19) United States
(12) Patent Application Publication
(10) Pub. No.: US 2002/0063777 A1
(43) Pub. Date: May 30, 2002

(54) Image transmission apparatus, image receiving apparatus, image transmitting and receiving system, and image receiving and transmitting method

(76) Inventors: Koji Maekawa, Yokohama-shi (JP); Akio Kobayashi, Yokohama-shi (JP); Shigeyuki Ogata, Yokohama-shi (JP); Katsumi Nakanishi, Yokosuka-shi (JP)

Correspondence Address: PEARNE & GORDON LLP, 526 SUPERIOR AVENUE EAST, SUITE 1200, CLEVELAND, OH, 44114-1484, US

(21) Appl. No.: 09/997,464

(22) Filed: Nov. 29, 2001

(30) Foreign Application Priority Data
Nov. 30, 2000 (JP) 2000-366213
Nov. 27, 2001 (JP) 2001-360185

(51) Int. Cl. H04N 7/18

(52) U.S. Cl. 348/143; 375/240.01; 348/153

(57) ABSTRACT

Herein disclosed is an image transmitting and receiving system comprising a plurality of image transmitting apparatus and one or more image receiving apparatus. Each of the image transmitting apparatus includes a plurality of camera units (10a to 10e) each for taking a moving picture of an object and a compressing and encoding unit (26) for compressing and encoding the moving image to generate coded moving image signal data. Each of the image receiving apparatus includes one or more decompressing and decoding units for decompressing and decoding the coded moving image signal data, and a monitoring unit (51) having a screen for displaying one moving picture on the screen when one moving image signal is outputted by the data outputting unit (58), and displaying a plurality of moving pictures on the screen when the synthesized moving image signal is outputted by the data outputting unit (58).

### BACKGROUND OF THE INVENTION

1. Field of the Invention

The present invention relates to an image transmission apparatus, an image receiving apparatus, an image transmitting and receiving system, and an image receiving and transmitting method, and more particularly to an apparatus, system for, and method of transmitting a moving image signal data and/or a sound signal data to and receiving a moving image signal data and/or a sound signal from multiple points through the Internet network.

2. Description of the Related Art

There have been proposed a wide variety of conventional image transmission apparatus for transmitting image signal data by way of, for example, a TCP/IP (Transmission Control Protocol/Internet Protocol) network at a transmission rate. The rapid increase in the transmission rate leads to a demand for transmitting sequential moving picture data such as movie film data in real time. The sequential moving picture data consists of a plurality of sequential moving picture signal data. A conventional image transmitting and receiving system for transmitting and receiving the sequential moving picture signal data comprises a conventional image transmission apparatus and a conventional image receiving apparatus. A conventional image transmission apparatus for transmitting the sequential moving picture signal data comprises an inputting unit for inputting the sequential moving picture signal data, a compressing and encoding unit for compressing and encoding the sequential moving picture signal data thus inputted, in accordance with a predetermined compressing and encoding method to generate coded sequential moving picture signal data, a transmitting unit for attaching address information about the image receiving apparatus to which the coded sequential moving picture signal data is directed, to the coded sequential moving picture signal data thus generated to generate transmission data portions to be transmitted through a network. Here, the transmission data portions consist of a plurality of packet data. The conventional image receiving apparatus comprises a receiving unit for receiving the transmission data portions through the network to reconstruct the coded sequential moving picture signal data, a decompressing and decoding unit for decompressing and decoding the coded sequential moving picture signal data to reconstruct the sequential moving picture signal data, and an outputting unit for outputting the sequential moving picture signal data to an external device.

One of the conventional image transmitting and receiving system of such a type is disclosed in the Japanese Patent Laid-Open Publication No. 10-336670. The conventional image transmitting and receiving system disclosed therein comprises a camera unit for taking a moving picture to be converted to a moving image signal, a motion picture server for compressing and encoding the moving image signal taken and converted by the camera unit to generate coded moving image signal data, a relay server for attaching address information about one or more client computers to which the coded moving image signal data are directed, to the coded moving image signal data to generate transmission data portions and transmitting the transmission data portions thus generated to the client computers in accordance with the address information. In this conventional image transmitting and receiving system, the relay server can transmit the transmission data portions to two or more client computers.

The conventional image transmitting and receiving system, however, encounters a drawback that the image transmission apparatus is required to have a relay system such as the relay server disclosed in the Japanese Patent Laid-Open Publication No. 10-336670 in order to transmit the transmission data portions to more than one image receiving apparatus.

Furthermore, the conventional image transmitting and receiving system encounters another drawback that the image receiving apparatus cannot receive the transmission data portions from more than one image transmission apparatus.

Furthermore, the conventional image transmitting and receiving system encounters another drawback that the image transmission apparatus or the image receiving apparatus is required to be electrically connected with an external storage device in order to store the coded moving image signal data thus compressed and encoded or decompressed and decoded or the transmission data portions thus transmitted or received.

Furthermore, the conventional image transmitting and receiving system encounters another drawback that the image transmission apparatus or the image receiving apparatus is required to be provided with a plurality of control units in order to control more than one camera unit and other external appliances electrically connected with the image transmission apparatus.

The present invention is made with a view to overcoming the previously mentioned drawbacks inherent to the conventional image transmitting and receiving system.

### SUMMARY OF THE INVENTION

It is therefore an object of the present invention to provide an image transmitting and receiving system in which the image transmission apparatus can reliably transmit the transmission data portions to a plurality of receiving apparatus respectively located at a plurality of monitoring points, thereby making it possible for the image transmission apparatus to directly transmit the transmission data portions to a plurality of image receiving apparatus without passing through any relay system.

It is another object of the present invention to provide an image transmitting and receiving system in which the image receiving apparatus can reliably receive the transmission data portions from a plurality of image transmission apparatus respectively located at a plurality of points to be monitored, thereby making it possible for the image receiving apparatus to directly receive the transmission data portions from a plurality of image transmission apparatus without passing through any relay system.

It is a further object of the present invention to provide an image transmitting and receiving system in which the image transmission apparatus or the image receiving apparatus comprise storage units, thereby making it possible to store the coded moving image signal data thus compressed and encoded or decompressed and encoded or the transmission data portions thus transmitted or received, directly in the image receiving apparatus or image transmission apparatus without being electrically connected with any additional external storage device.

It is a still further object of the present invention to provide an image transmitting and receiving system in which the transmission apparatus or the image receiving apparatus can directly control a plurality of camera units and other external appliances, thereby making it possible to eliminate the need for any additional external control unit.

It is a yet further object of the present invention to provide a method of reliably transmitting the transmission data portions to a plurality of image receiving apparatus respectively located at a plurality of monitoring points, thereby making it possible to directly transmit the transmission data portions to a plurality of image receiving apparatus without passing through any relay system.

It is a yet further object of the present invention to provide a method of reliably receiving the transmission data portions from a plurality of image transmission apparatus respectively located at a plurality of monitoring points, thereby making it possible to directly receive the transmission data portions from a plurality of image transmission apparatus without passing through any relay system.

It is a yet further object of the present invention to provide a method of storing the coded moving image signal data thus compressed and encoded or decompressed and encoded or the transmission data portions thus transmitted or received, directly in the image receiving apparatus or image transmission apparatus without being electrically connected with any additional external storage device.

It is a yet farther object of the present invention to provide a method of directly controlling a plurality of camera units and other external appliances, thereby making it possible to eliminate the need for any additional external control unit.

In accordance with a first aspect of the present invention, there is provided an image transmitting and receiving system comprising a plurality of data transmission means each for transmitting one or more transmission data portions each generated as a result of compressing and encoding one or more moving image signals taken by respective camera units; and one or more data receiving means each for receiving the one or more transmission data portions transmitted by the data transmission means through a network.

Each of the aforesaid data transmission means may include: a plurality of camera units each for taking a moving picture of an object; an image inputting unit operatively connected with the camera units for operating one or more the camera units to input one or more moving pictures taken by the one or more camera units to be converted to one or more moving image signals; an image synthesizing unit for passing through the moving image signal when one moving image signal is converted by the image inputting unit and synthesizing more than one moving image signal to generate a synthesized moving image signal when more than one moving image signal is converted by the image inputting unit; a compressing and encoding unit for compressing and encoding the moving image signal passed through by the image synthesizing unit when the image synthesizing unit passes through one moving image signal and compressing and encoding the synthesized moving image signal generated by the image synthesizing unit when the image synthesizing unit synthesizes more than one moving image signal to generate coded moving image signal data; one or more data transmitting units for inputting the coded moving image signal data generated by the compressing and encoding unit, generating address information about the one or more data receiving means to which the coded moving image signal data is directed, and attaching address information about the one or more data receiving means to the coded moving image signal data to generate one or more transmission data portions directed to the respective one or more data receiving means; a transmission line connection control unit for inputting the one or more transmission data portions generated by the one or more data transmitting units, establishing and maintaining one or more line connections between the one or more data transmitting units and respective one or more data receiving means in accordance with the address information attached in the one or more transmission data portions so as to transmit the one or more transmission data portions through the network to the respective one or more data receiving means, and generating line connection state information; and a transmission control unit for controlling the image inputting unit, the image synthesizing unit, and the transmission line connection control unit in accordance with the line connection state information generated by the transmission line connection control unit.

Each of the aforesaid data receiving means may include: a receiving line connection control unit for receiving the one or more transmission data portions transmitted by the respective one or more data transmission means; one or more data receiving units for receiving the one or more transmission data portions to reconstruct coded moving image signal data, the receiving line connection control unit operative to establish and maintain one or more line connections between the one or more data receiving units and the respective one or more data transmission means in accordance with the address information attached in the one or more transmission data portions so as to receive the one or more transmission data portions through the network from the respective one or more data transmission means; one or more decompressing and decoding units electrically connected with the respective one or more data receiving units in one-to-one relationship for decompressing and decoding the coded moving image signal data reconstructed by the respective one or more data receiving units to reconstruct one or more moving image signals or synthesized moving image signals; an image synthesizing unit for passing through the moving image signal or the synthesized moving image signal when one moving image signal or one synthesized moving image signal is reconstructed by the one or more decompressing and decoding units and synthesizing more than one moving image signal or synthesized moving image signal to generate a synthesized moving image signal when more than one moving image signal or synthesized moving image signal is reconstructed by the one or more decompressing and decoding units; a data outputting unit for outputting the moving image signal or the synthesized moving image signal passed through by the image synthesizing unit when the image synthesizing unit passes through the moving image signal or the synthesized moving image signal, and outputting the synthesized moving image signal synthesized by the image synthesizing unit when the image synthesizing unit generates the synthesized moving image signal; a monitoring unit having a screen for displaying one moving picture on the screen when the moving image signal is outputted by the data outputting unit, and displaying a plurality of moving pictures on the screen when the synthesized moving image signal is outputted by the data outputting unit; an operation unit for inputting an operation instruction therethrough; and a receiving control unit for generating an operation request in accordance with the operation instruction inputted by the operation unit, controlling the receiving line connection control unit in accordance with the operation request and the one or more transmission data portions transmitted by the respective one or more data transmission means.

In the aforesaid image transmitting and receiving system, the data transmission means further may include: a sound collecting unit for collecting sounds to be converted into sound signals; and a sound inputting unit for inputting the sound signals converted by the sound collecting unit; the compressing and encoding unit is operative to compress and encode the synthesized moving image signal synthesized by the image synthesizing unit and the sound signals inputted by the sound inputting unit to generate coded moving image signal data and coded sound signal data; the one or more data transmitting units are operative to input the coded moving image signal data and the coded sound data generated by the compressing and encoding unit, to generate address information about the one or more data receiving means to which the coded moving image signal data and the coded sound signal data are directed, and to attach the address information about the one or more data receiving means to the coded moving image signal data and the coded sound data to generate one or more transmission data portions directed to the respective one or more data receiving means, the one or more data receiving units are operative to receive the one or more transmission data portions to reconstruct the coded moving image signal data and the coded sound signal data; the one or more decompressing and decoding units are operative to decompress and decode the coded moving image signal data and the coded sound signal data reconstructed by the one or more data receiving units to reconstruct one or more synthesized moving image signals and sound signals; the image synthesizing unit is operative to pass through the moving image signal or the synthesized moving image signal when one moving image signal or one synthesized moving image signal is reconstructed by the one or more decompressing and decoding units, and to synthesize more than one moving image signal or synthesized moving image signal to generate a synthesized moving image signal when more than one moving image signal or synthesized moving image signal is reconstructed by the one or more decompressing and decoding units, and to pass through the sound signals decompressed and decoded by the one or more decompressing and decoding units the data outputting unit is operative to output the moving image signal passed through by the image synthesizing unit when the image synthesizing unit passes through the moving image signal, and to output the synthesized moving image signal synthesized by the image synthesizing unit when the image synthesizing unit generates the synthesized moving image signal, and to output the sound signals passed through by the image synthesizing unit; and the monitoring unit is further provided with a speaker and operative to display one moving picture on the screen when the moving image signal is outputted by the data outputting unit, and to display a plurality of moving pictures on the screen when the synthesized moving image signal is outputted by the data outputting unit, and to audibly output the sound signals outputted by the data outputting unit.

In the aforesaid image transmitting and receiving system, the camera unit may include a camera portion positioned at a predetermined position and provided with a charged coupled device for taking a moving picture at a predetermined shutter speed, a driving unit for having the camera portion moved horizontally and vertically, and an image processing circuit for converting the moving picture into moving image signal.

In the aforesaid image transmitting and receiving system, one of the camera units may be operative to take a moving picture of a respective object at a time, the image inputting unit includes a camera switching circuit for switching one of the camera units operative to take a moving picture to another camera unit operative to take another moving picture at a predetermined interval in a predetermined order, an analog to digital converter for converting the moving picture taken by the camera unit into the moving image signal, and a memory buffer for temporally storing the moving image signal, and the transmission control unit is operative to control the image inputting unit in accordance with the line connection state information so as to input one moving picture taken by one camera unit to be converted to one moving image signal or more than one moving picture taken by more than one camera unit to be converted to more than one moving image signal.

In the aforesaid image transmitting and receiving apparatus, the address information may include addresses of more than one data receiving means, and one of the one or more data transmitting units is operative to attach the address information about the more than one data receiving means to the coded moving image signal data generated by the compressing and encoding unit to generate one or more transmission data portion each directed to the more than one data receiving means, the transmission line connection control unit is operative to input the one or more transmission data portions generated by the one of the one or more data transmitting units, establishing and maintaining one or more line connections between the one of the one or more data transmitting units and respective one or more data receiving means in accordance with the address information attached in the one or more transmission data portions so as to transmit the one or more transmission data portions through the network to the respective one or more data receiving means.

### BRIEF DESCRIPTION OF THE DRAWINGS

The features and advantages of the reproduction apparatus and method according to the present invention will be more clearly understood from the following description taken in conjunction with the accompanying drawings in which:

FIG. 1 is a block diagram showing a first preferred embodiment of an image transmitting and receiving system which comprises a plurality of image transmission apparatus and image receiving apparatus according to the present invention,

FIG. 2 is a block diagram of the image transmission apparatus forming part of the image transmitting and receiving system shown in FIG. 1,

FIG. 3 is a block diagram of the image receiving apparatus forming part of the image transmitting and receiving system shown in FIG. 1,

FIG. 4 is a block diagram of a modified embodiment of the image transmission apparatus according to the present invention,

FIG. 5 is a block diagram of a modified embodiment of the image receiving apparatus according to the present invention,

FIG. 6 is a block diagram of another modified embodiment of the image receiving apparatus according to the present invention, and

FIG. 7 is a block diagram of a second preferred embodiment of the image transmitting and receiving system according to the present invention.

### DESCRIPTION OF THE PREFERRED EMBODIMENTS

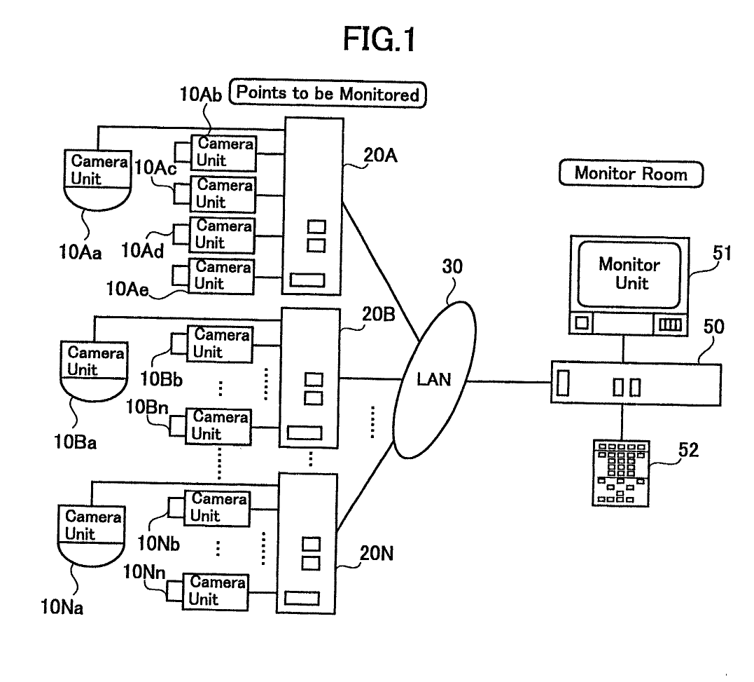

The preferred embodiments of the image transmitting and receiving system according to the present invention will be described hereinafter with reference to FIGS. 1 to 7.

Referring now to FIGS. 1 to 3 of the drawings, there is shown a first preferred embodiment of the image transmitting and receiving system according to the present invention.

The first embodiment of the image transmitting and receiving system is shown in FIG. 1 as comprising a plurality of image transmission apparatus 20A to 20N for transmitting one or more transmission data portions and image receiving apparatus 50 and other image receiving apparatus (not shown) for receiving the one or more transmission data portions transmitted by the image transmission apparatus 20A to 20N through a LAN (Local Area Network) network 30. The image transmission apparatus 20A to 20N are located at, for example, a plurality of points to be monitored. The image receiving apparatus 50 and the other image receiving apparatus are located at, for example, a plurality of monitor rooms, i.e., monitoring points. The image transmission apparatus 20A, 20B . . . , 20N respectively includes a plurality of camera units (10Aa to 10Ae, 10Ba to 10Bn . . . , 10Na to 10Nn) located at a plurality of monitoring points. Here, the transmission data portions are generated as a result of compressing and encoding one or more moving image signals taken by camera units. The image receiving apparatus 50 includes a monitor unit 51 and an operation unit 52. The image transmission apparatus constitutes the data transmission means according to the present invention. The image receiving apparatus constitutes the data receiving means according to the present invention.

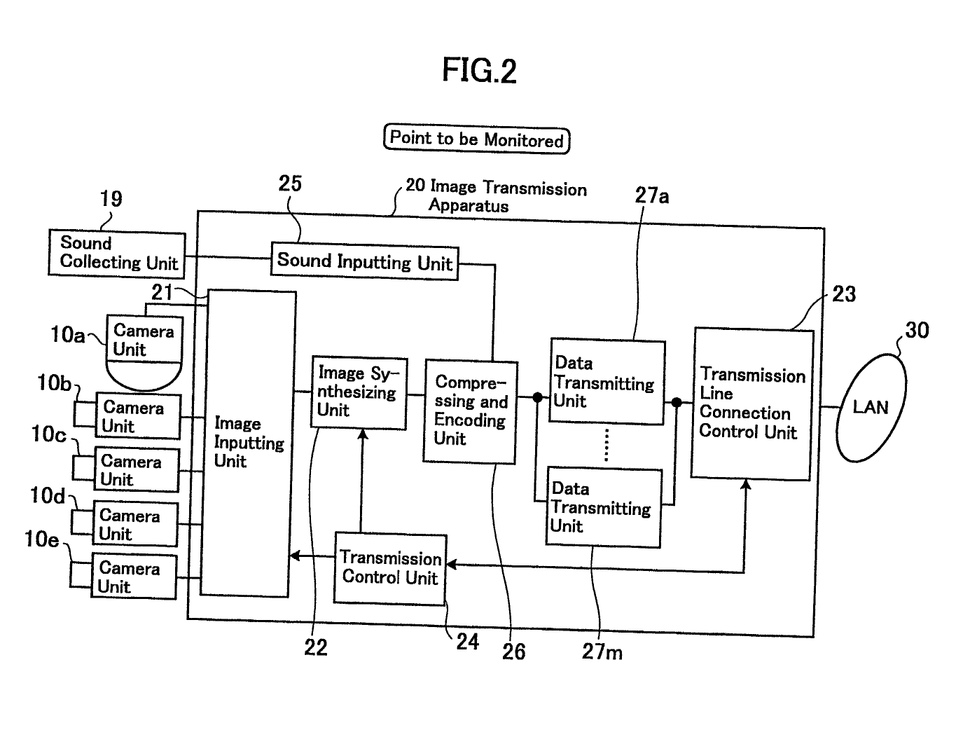

The image transmitting and receiving system according to the present invention, there are provided a plurality of image transmission apparatus, i.e., the image transmission apparatus 20A to 20N. The image transmission apparatus 20A to 20N are similar in construction to one another. Image transmission apparatus 20 shown in FIG. 2 includes all the constructions and functions common to all of the image transmission apparatus 20A and 20N. Description will now be made on how the image transmission apparatus 20A to 20N are operative to transmit the transmission data portions with reference to the image transmission apparatus 20.

The image transmission apparatus 20 is shown in FIG. 2 as comprising a plurality of camera units 10a to 10e, an image inputting unit 21, an image synthesizing unit 22, a compressing and encoding unit 26, one or more data transmitting units 27a to 27m, a transmission line connection control unit 23, and a transmission control unit 24.

Each of the camera units 10a to 10e is adapted to take a moving picture of an object. The image inputting unit 21 is operatively connected with the camera units 10a to 10e and adapted to operate one or more the camera units 10a to 10e to input one or more moving pictures taken by the one or more camera units 10a to 10e to be converted to one or more moving image signals. The image synthesizing unit 22 is adapted to pass through the moving image signal when one moving image signal is converted by the image inputting unit 21. The image synthesizing unit 22, on the other hand, is adapted to synthesize more than one moving image signal to generate a synthesized moving image signal when more than one moving image signal is converted by the image inputting unit 21.

The compressing and encoding unit 26 is adapted to compress and encode the moving image signal passed through by the image synthesizing unit 22 when the image synthesizing unit 22 passes through one moving image signal to generate coded moving image signal data. The compressing and encoding unit 26, on the other hand, is adapted to compress and encode the synthesized moving image signal generated by the image synthesizing unit 22 to generate coded moving image signal data when the image synthesizing unit 22 synthesizes more than one moving image signal.

The one or more data transmitting units 27a to 27m are adapted to input the coded moving image signal data generated by the compressing and encoding unit 26, generate address information about the image receiving apparatus 50 and other image receiving apparatus to which the coded moving image signal data is directed, and attach the address information about the image receiving apparatus 50 and other data receiving means to the coded moving image signal data to generate one or more transmission data portions directed to the image receiving apparatus 50 and other data receiving means.

The image transmission apparatus 20 can transmit the transmission data portions to one image receiving apparatus 50 only. According to the present invention, the image transmission apparatus 20, however, is capable of transmitting transmission data portions to a plurality of image receiving apparatus located at respective points. The number of data transmitting units corresponds to the number of data receiving means to which the coded moving image signal data is directed. It is hereinlater assumed that that the one or more transmission data portions are directed to the image receiving apparatus 50 and the other data receiving means.

The image receiving apparatus 50 and other data receiving mean can receive the one or more transmission data portions at respective input bit rates. In the image transmission apparatus 20 according to the present invention, the one or more data transmitting units 27a to 27m is adapted to generate one or more transmission data portions directed to the image receiving apparatus 50 and other data receiving means at the respective bit rates by way of adaptively reducing the volume of information to be contained in the one or more transmission data portions.

The transmission line connection control unit 23 is adapted to input the one or more transmission data portions generated by the one or more data transmitting units 27a to 27m, establish and maintain one or more line connections between the one or more data transmitting units 27a to 27m and respective image receiving apparatus 50 and the other image receiving apparatus in accordance with the address information attached in the one or more transmission data portions so as to transmit the one or more transmission data portions through the network 30 to the respective image receiving apparatus 50 and the other image receiving apparatus. Furthermore, the transmission line connection control unit 23 is adapted to generate line connection state information. The transmission control unit 24 is adapted to control the image inputting unit 21, the image synthesizing unit 22, and the transmission line connection control unit 23 in accordance with the line connection state information generated by the transmission line connection control unit 23.

The operation of the image transmission apparatus 20 will be described hereinlater.

Each of the camera units 10a to 10e is operated to take a moving picture of an object. The image inputting unit 21 is operated to operate one or more the camera units 10a to 10e to input one or more moving pictures taken by the one or more camera units 10a to 10e to be converted to one or more moving image signals. The image synthesizing unit 22 is operated to pass through the moving image signal when one moving image signal is converted by the image inputting unit 21. The image synthesizing unit 22, on the other hand, is operated to synthesize more than one moving image signal to generate a synthesized moving image signal when more than one moving image signal is converted by the image inputting unit 21.

The compressing and encoding unit 26 is operated to compress and encode the moving image signal passed through by the image synthesizing unit 22 when the image synthesizing unit 22 passes through one moving image signal to generate coded moving image signal data. The compressing and encoding unit 26, on the other hand, is operated to compress and encode the synthesized moving image signal generated by the image synthesizing unit 22 to generate coded moving image signal data when the image synthesizing unit 22 synthesizes more than one moving image signal.

The one or more data transmitting units 27a to 27m are operated to input the coded moving image signal data generated by the compressing and encoding unit 26, generate address information about the image receiving apparatus 50 and other image receiving apparatus to which the coded moving image signal data is directed, and attach the address information about the image receiving apparatus 50 and other data receiving means to the coded moving image signal data to generate one or more transmission data portions directed to the image receiving apparatus 50 and other data receiving means.

The transmission line connection control unit 23 is operated to input the one or more transmission data portions generated by the one or more data transmitting units 27a to 27m, establish and maintain one or more line connections between the one or more data transmitting units 27a to 27m and respective image receiving apparatus 50 and the other image receiving apparatus in accordance with the address information attached in the one or more transmission data portions so as to transmit the one or more transmission data portions through the network 30 to the respective image receiving apparatus 50 and the other image receiving apparatus. Furthermore, the transmission line connection control unit 23 is operated to generate line connection state information. The transmission control unit 24 is operated to control the image inputting unit 21, the image synthesizing unit 22, and the transmission line connection control unit 23 in accordance with the line connection state information generated by the transmission line connection control unit 23.

As will be seen from the foregoing description it is to be understood that the image transmission apparatus 20 located at a point to be monitored, in the image transmitting and receiving system thus constructed, can reliably transmit the transmission data portions to the image receiving apparatus 50 and other image receiving apparatus, i.e., a plurality of the image receiving apparatus respectively located at a plurality of monitoring points, thereby making it possible for the image transmission apparatus 20 to directly transmit the transmission data portions to the image receiving apparatus 50 and other image receiving apparatus, i.e., a plurality of image receiving apparatus without passing through any relay system.

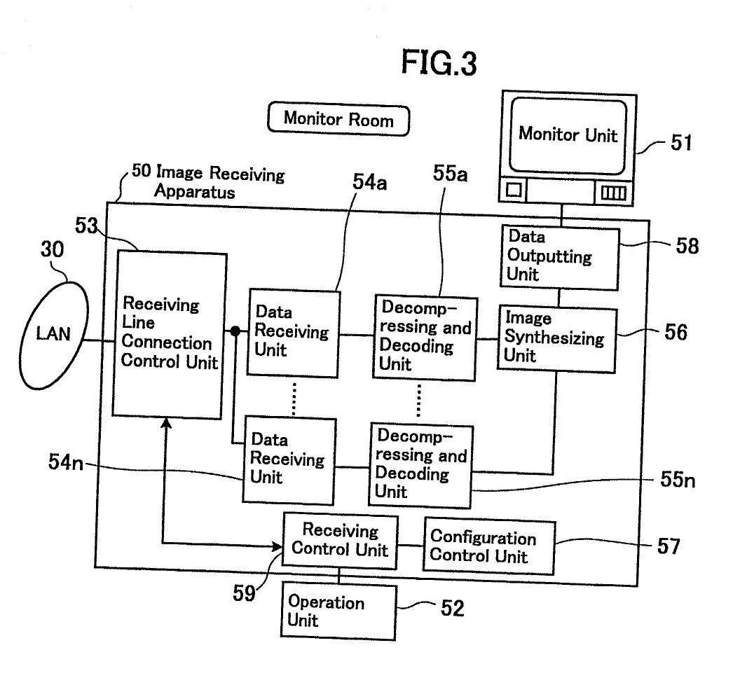

The image transmitting and receiving system according to the present invention, there may be provided the image receiving apparatus 50 and the other image receiving apparatus, i.e., a plurality of image receiving apparatus. The image receiving apparatus 50 and the other image receiving apparatus are similar in construction and function to one another. The image receiving apparatus 50 shown in FIG. 3 includes all the constructions and functions common to all of the image receiving apparatus 50 and the other image receiving apparatus. Description will then be made on how the image receiving apparatus 50 and other image receiving apparatus are operative to receive the transmission data portions with reference to the image receiving apparatus 50.

The image receiving apparatus 50 is shown in FIG. 3 as comprising a receiving line connection control unit 53, one or more data receiving units 54a to 54n, one or more decompressing and decoding units 55a to 55n, an image synthesizing unit 56, a data outputting unit 58, a monitoring unit 51, an operation unit 52, a configuration control unit 57, and a receiving control unit 59.

The receiving line connection control unit 53 is adapted to receive the one or more transmission data portions transmitted by the respective image transmission apparatus 20A to 20N. The one or more data receiving units 54a to 54n are adapted to receive the one or more transmission data portions to reconstruct coded moving image signal data. The receiving line connection control unit 53 is operative to establish and maintain one or more line connections between the one or more data receiving units 54a to 54n and the respective image transmission apparatus 20A to 20N in accordance with the address information attached in the one or more transmission data portions so as to receive the one or more transmission data portions through the network 30 from the respective image transmission apparatus 20A to 20N. The data receiving units 54a to 54n correspond to respective image transmission apparatus 20A to 20N. The image receiving apparatus 50 can receive the transmission data portions from one of the image transmission apparatus 20A to 20N only. The receiving line connection control unit 53 is operative to establish and maintain one line connection between the one of the image transmission apparatus 20A to 20N and the corresponding one of the data receiving units 54a to 54n in the case that the one of the receiving apparatus 50 receives the transmission data portions from one of the image transmission apparatus 20A to 20N.

The one or more decompressing and decoding units 55a to 55n are electrically connected with the respective one or more data receiving units 54a to 54n in one-to-one relationship. The one or more decompressing and decoding units 55a to 55n are adapted to decompress and decode the coded moving image signal data reconstructed by the respective one or more data receiving units 54a to 54n to reconstruct one or more moving image signals or synthesized moving image signals.

The image synthesizing unit 56 is adapted to pass through the moving image signal or the synthesized moving image signal when one moving image signal or one synthesized moving image signal is reconstructed by the one or more decompressing and decoding units 55a to 55n. The image synthesizing unit 56, on the other hand, is adapted to synthesize more than one moving image signal or synthesized moving image signal to generate a synthesized moving image signal when more than one moving image signal or synthesized moving image signal is reconstructed by the one or more decompressing and decoding units 55a to 55n.

The data outputting unit 58 is adapted to output the moving image signal or the synthesized moving image signal passed through by the image synthesizing unit 56 when the image synthesizing unit 56 passes through the moving image signal or the synthesized moving image signal. The data outputting unit 58, on the other hand, is adapted to output the synthesized moving image signal synthesized by the image synthesizing unit 56 when the image synthesizing unit 56 generates the synthesized moving image signal. The monitoring unit 51 has a screen. The monitoring unit 51 is adapted to display one moving picture on the screen when the moving image signal is outputted by the data outputting unit 58. The monitoring unit 51, on the other hand, is adapted to display a plurality of moving pictures on the screen when the synthesized moving image signal is outputted by the data outputting unit 58.

The operation unit 52 is designed to be used by an operator to input an operation instruction, which will be described later, therethrough. The receiving control unit 59 is adapted to generate an operation request in accordance with the operation instruction inputted by the operation unit 52. The receiving control unit 59 is adapted to control the receiving line connection control unit 53 in accordance with the operation request and the one or more transmission data portions transmitted by the respective one or more image transmission apparatus 20A to 20N.

The configuration control unit 57 has a configuration storage portion and is adapted to input configuration conditions to be stored therein.

The operation of the image receiving apparatus 50 will be described hereinlater.

The receiving line connection control unit 53 is operated to receive the one or more transmission data portions transmitted by the respective image transmission apparatus 20A to 20N. The one or more data receiving units 54a to 54n are operated to receive the one or more transmission data portions to reconstruct coded moving image signal data. The receiving line connection control unit 53 is operated to establish and maintain one or more line connections between the one or more data receiving units 54a to 54n and the respective image transmission apparatus 20A to 20N in accordance with the address information attached in the one or more transmission data portions so as to receive the one or more transmission data portions through the network 30 from the respective image transmission apparatus 20A to 20N. The receiving line connection control unit 53, on the other hand, is operated to establish and maintain one line connection between the one of the image transmission apparatus 20A to 20N and the corresponding one of the data receiving units 54a to 54n in the case that the one of the receiving apparatus 50 receives the transmission data portions from one of the image transmission apparatus 20A to 20N.

The one or more decompressing and decoding units 55a to 55n are operated to decompress and decode the coded moving image signal data reconstructed by the respective one or more data receiving units 54a to 54n to reconstruct one or more moving image signals or synthesized moving image signals.

The image synthesizing unit 56 is operated to pass through the moving image signal or the synthesized moving image signal when one moving image signal or one synthesized moving image signal is reconstructed by the one or more decompressing and decoding units 55a to 55n. The image synthesizing unit 56, on the other hand, is operated to synthesize more than one moving image signal or synthesized moving image signal to generate a synthesized moving image signal when more than one moving image signal or synthesized moving image signal is reconstructed by the one or more decompressing and decoding units 55a to 55n.

The data outputting unit 58 is operated to output the moving image signal or the synthesized moving image signal passed through by the image synthesizing unit 56 when the image synthesizing unit 56 passes through the moving image signal or the synthesized moving image signal. The data outputting unit 58, on the other hand, is operated to output the synthesized moving image signal synthesized by the image synthesizing unit 56 when the image synthesizing unit 56 generates the synthesized moving image signal. The monitoring unit 51 has a screen. The monitoring unit 51 is operated to display one moving picture on the screen when the moving image signal is outputted by the data outputting unit 58. The monitoring unit 51, on the other hand, is operated to display a plurality of moving pictures on the screen when the synthesized moving image signal is outputted by the data outputting unit 58.

The receiving control unit 59 is operated to generate an operation request in accordance with the operation instruction inputted by the operation unit 52. The receiving control unit 59 is operated to control the receiving line connection control unit 53 in accordance with the operation request and the one or more transmission data portions transmitted by the respective one or more image transmission apparatus 20A to 20N.

The configuration control unit 57 is operated to input configuration conditions to be stored therein.

As will be seen from the foregoing description, it is to be understood the image receiving apparatus 50 located at a monitoring point, in the image transmitting and receiving system thus constructed, can receive the transmission data portions from a plurality of image transmission apparatus 20A to 20N respectively located at a plurality of points to be monitored, thereby making it possible for the image receiving apparatus 50 to directly receive the transmission data portions from a plurality of image transmission apparatus 20A to 20N without passing through any relay system.

According to the present invention, the image receiving apparatus 50 can receive one or more transmission data portions transmitted by another image transmission apparatus 20, and the receiving line connection control unit 53 of the image receiving apparatus 50 is adapted to establish and maintain another line connection between another one of the data receiving units 54a to 54n and the another image transmission apparatus 20 in response to the one or more transmission data portions transmitted by another image transmission apparatus 20 while the image receiving apparatus 50 maintains a line connection with one image transmission apparatus 20.

The operation of the image transmission apparatus 20 and the image receiving apparatus 50 in response to the transmission data portions transmitted by another image transmission apparatus 20 will be described hereinlater.

The image receiving apparatus 50 is operated to receive one or more transmission data portions transmitted by another image transmission apparatus, for example, image transmission apparatus 20B. The receiving line connection control unit 53 of the image receiving apparatus 50 is then operated to establish and maintain another line connection between another one of the data receiving units 54a to 54n and the another image transmission apparatus 20B in response to the one or more transmission data portions transmitted by another image transmission apparatus 20B while the image receiving apparatus 50 maintains a line connection between the image receiving apparatus 50 and one image transmission apparatus, for example, image transmission apparatus 20A, i.e., the receiving line connection control unit 53 maintains a line connection between one of the data receiving units 54a to 54n and one image transmission apparatus 20A. According to the present invention, the image receiving apparatus 50 may also disconnect the line connection with the image transmission apparatus 20A when the receiving line connection control unit 53 establishes another line connection with another image transmission apparatus 20B.

As will be seen from the foregoing description, it is to be understood that the image receiving apparatus 50, in the image transmitting and receiving system according to the present invention, can reliably receive the transmission data portions from a plurality of image transmission apparatus, i.e., image transmission apparatus 20A and image transmission apparatus 20B.

According to the present invention, the image transmission apparatus 20 can transmit the transmission data portions to another image receiving apparatus while the image transmission apparatus 20 maintains a line connection with and transmits the transmission data portions one image receiving apparatus 50

The operation of the image transmission apparatus 20 and another image receiving apparatus will be described hereinlater.

The image transmission apparatus 20 is operated to transmit one or more transmission data portions to another image receiving apparatus while the image transmission apparatus 20 maintains a line connection between the image receiving apparatus 50 and the image transmission apparatus 20, and the transmission line connection control unit 23 maintains a line connection between one of the data transmitting units 27a to 27m and the image receiving apparatus 50 so as to transmit the one or more transmission data portions generated by the one of the data transmitting units 27a to 27m to the image receiving apparatus 50.

In the image transmission apparatus 20, the transmission line connection control unit 23 is operated to establish and maintain another line connection between the another image receiving apparatus and another one of the data transmitting units 27a to 27m so as to transmit the one or more transmission data portions to the another image receiving apparatus. The receiving line connection control unit 53 of the another image receiving apparatus is operated to establish and maintain the line connection between one of the data receiving units 54a to 54n and the image transmission apparatus 20 to receive the one or more transmission data portions transmitted by the image transmission apparatus 20.

As will be seen from the foregoing description, it is to be understood that the image transmission apparatus 20, in the image transmitting and receiving system thus constructed, can reliably transmit the transmission data portions to the image receiving apparatus 50 and other image receiving apparatus, i.e., a plurality of the image receiving apparatus respectively located at a plurality of monitoring points, thereby making it possible for the image transmission apparatus 20 to directly transmit the transmission data portions to the image receiving apparatus 50 and other image receiving apparatus, i.e., a plurality of image receiving apparatus without passing through any relay system.

According to the present invention, the image transmission apparatus 20 and image receiving apparatus 50 can restore the line connection when the line connection between the image transmission apparatus 20 and the image receiving apparatus 50 is disconnected.

The operation of the image transmission apparatus 20 and the image receiving apparatus 50 when the line connection is disconnected will be described hereinlater.

The transmission line connection control unit 23 is operated to restore and maintain the line connection between one of the data transmitting units 27a to 27m and the image receiving apparatus 50 so as to transmit the one or more transmission data portions generated by the one of the data transmitting units 27a to 27m through the network 30 to the image receiving apparatus 50 when a line connection between image transmission apparatus 20 and image receiving apparatus 50 is disconnected while one of the data transmitting units 27a to 27m of the image transmission apparatus 20 is transmitting one or more transmission data portions through the network 30 to the image receiving apparatus 50. The receiving line connection control unit 53 is operated to restore and maintain the line connection between one the data receiving units 54a to 54n and the image transmission apparatus 20 to receive the one or more transmission data portions transmitted by the image transmission apparatus 20.

As will be seen from the foregoing description, it is to be understood that the image receiving apparatus 50, in the image transmitting and receiving system according to the present invention, can reliably receive the transmission data portions from the image transmission apparatus 20.

As described hereinbefore, the operation unit 52 of the image receiving apparatus 50 is adapted to be used by an operator to input an operation instruction. The operation instruction may include a synthesizing operation instruction for synthesizing specified moving image signals or synthesized moving image signals for the image synthesizing unit 56.

The operation of the image receiving apparatus 50 and the image transmission apparatus 20 in response to the operation unit 52 will be described hereinlater.

The operation unit 52 is operated to input a synthesizing operation instruction for synthesizing specified moving image signals or synthesized moving image signals for the image synthesizing unit 56. The receiving control unit 59 is operated to generate a synthesizing operation request in accordance with the synthesizing operation instruction inputted by the operation unit 52. The image synthesizing unit 56 is operated to select specified moving image signals or synthesized moving image signals from among the moving image signals or synthesized moving image signals reconstructed by the one or more decompressing and decoding units 55a to 55n in accordance with the synthesizing operation request generated by the receiving control unit 59 and synthesize the specified moving image signals or synthesized moving image signals to generate a synthesized moving image signal when the specified moving image signals or synthesized moving image signals are reconstructed by the one or more decompressing and decoding units 55a to 55n.

The image receiving apparatus 50 thus constructed can synthesize the specified moving image signals or synthesized moving image signals in accordance with the operation instruction. This means that the image receiving apparatus 50 can efficiently utilize the transmission data portions transmitted by the image transmission apparatus 20. This leads to the fact that the image receiving apparatus 50 thus constructed can reliably receive the transmission data portions from the image transmission apparatus 20.

While it has been described in the above that a plurality of image transmission apparatus 20A to 20N are operative to transmit transmission data portions containing a moving image signal, and the image receiving apparatus 50 and other image receiving apparatus are operative to receive the transmission data portions including the moving image signals transmitted by the image transmission apparatus 20A to 20N through a LAN network 30, the image transmission apparatus 20A to 20N may transmit transmission data portions including moving image signals and sound signals, and the image receiving apparatus 50 and other image receiving apparatus are operative to receive the transmission data portions including the moving image signals and the sound signals transmitted by the image transmission apparatus 20A to 20N through a LAN network 30 in the first embodiment of the image transmitting and receiving system according to the present invention.

As described above, the image transmission apparatus 20 includes all the constructions and functions common to all of the image transmission apparatus 20A and 20N. Description will now be made on how the image transmission apparatus 20A to 20N are operative to transmit the transmission data portions including sound signals with reference to the image transmission apparatus 20.

As best shown in FIG. 2, the image transmission apparatus 20 further comprises a sound collecting unit 19 and a sound inputting unit 25.

The sound collecting unit 19 is adapted to collect sounds to be converted into sound signals. The sound inputting unit 25 is adapted to input the sound signals converted by the sound collecting unit 19.

The operation of the data transmission apparatus 20 will be described hereinlater.

The compressing and encoding unit 26 is operated to compress and encode the synthesized moving image signal synthesized by the image synthesizing unit 22 and the sound signals inputted by the sound inputting unit 25 to generate coded moving image signal data and coded sound signal data. The one or more data transmitting units 27a to 27m are operated to input the coded moving image signal data and the coded sound data generated by the compressing and encoding unit 26, to generate address information about the image receiving apparatus 50 and the other image receiving apparatus to which the coded moving image signal data and the coded sound signal data are directed, and to attach the address information about the image receiving apparatus 50 and the other image receiving apparatus to the coded moving image signal data and the coded sound data to generate one or more transmission data portions directed to the respective image receiving apparatus 50 and the other image receiving apparatus.

Here, the transmission data portions consist of a plurality of packet data. Each of the transmission data portions thus generated may contain a TCP header and an IP header for the TCP/IP communication. The IP header may further include the IP address of the sender, i.e., the image transmission apparatus 20 from which the coded moving image signal data and the coded sound signal data are transmitted, and the IP addresses of the receivers, i.e., the image receiving apparatus 10 and other data receiving means to which the coded moving image signal data and coded sound signal data are directed.

In the image transmission apparatus 20 according to the present invention, the address information may include more than one address of more than one image receiving apparatus such as, for example, addresses of the image receiving apparatus 50 and other data receiving means. This means that one of the one or more data transmitting units 27a to 27m, for example, may attach the address information about the image receiving apparatus 50 and other data receiving means to the same coded moving image signal data generated by the compressing and encoding unit 26 to generate one or more transmission data portion each directed to the image receiving apparatus 50 and other data receiving means so as to multicast the coded moving image signal data.

The transmission line connection control unit 23 is operated to input the one or more transmission data portions generated by the one of the one or more data transmitting units 27a to 27m, to establish and maintain one or more line connections between the one of the one or more data transmitting units 27a to 27m and respective image receiving apparatus 50 and other data receiving means in accordance with the address information attached in the one or more transmission data portions so as to transmit the one or more transmission data portions through the network to the respective image receiving apparatus 50 and other data receiving means.

As will be seen from the foregoing description it is to be understood that the image transmission apparatus 20, in the image transmitting and receiving system thus constructed, can reliably transmit the transmission data portions including moving image signals and sound signals to the image receiving apparatus 50 and other image receiving apparatus, i.e., one or more image receiving apparatus respectively located at one or more monitoring points, thereby making it possible for the image transmission apparatus 20 to directly transmit the transmission data portions including moving image signals and sound signals to the image receiving apparatus 50 and other image receiving apparatus, i.e., one or more image receiving apparatus without passing through any relay system.

As described above, the image receiving apparatus 50 includes all the constructions and functions common to all of the image receiving apparatus 50 and the other image receiving apparatus. Description will now be made on how the image receiving apparatus 50 and other image receiving apparatus are operative to receive the transmission data portions including the sound signals with reference to the image receiving apparatus 50.

The operation of the image receiving apparatus 50 will be described hereinlater.

In the image receiving apparatus 50, the receiving line connection control unit 53 is operated to receive the one or more transmission data portions transmitted by the image transmission apparatus 20 and other image transmission apparatus. The image receiving apparatus 50 can receive the transmission data portions from one image transmission apparatus 20 alone. According to the present invention, the image receiving apparatus 50, however, is capable of receiving the transmission data portions from a plurality of image transmission apparatus. It is hereinlater assumed that the one or more transmission data portions are received from the image transmission apparatus 20A to 20N.

The receiving line connection control unit 53 is operated to output the one or more transmission data portions to respective data receiving units 54a to 54n in accordance with the address information including the address of the sender, i.e., the image transmission apparatus 20A to 20N. The data receiving units 54a to 54n of the image receiving apparatus 50 respectively correspond to the image transmission apparatus 20A to 20N. In the image receiving apparatus 20 according to the present invention, the receiving line connection control unit 53 is operated to output the one or more transmission data portions to data receiving units 54a to 54n in the order that the respective line connections are established. This means that the receiving line connection control unit 53 is operated to output a transmission data portion from, for example, the image transmission apparatus 20A which the line connection was firstly established to, for example, the data receiving unit 54a. The receiving line connection control unit 53 is then operated to output a second transmission data portion from, for example, the image transmission apparatus 20C which the line connection was secondly established to, for example, the data receiving unit 54b.

The one or more data receiving units 54a to 54n are operated to receive the one or more transmission data portions to reconstruct the coded moving image signal data and the coded sound signal data to be outputted to the respective decompressing and decoding units 55a to 55n. The one or more decompressing and decoding units 55a to 55n are operated to decompress and decode the coded moving image signal data and the coded sound signal data reconstructed by the respective one or more data receiving units 54a to 54n to reconstruct one or more synthesized moving image signals and sound signals.

The image synthesizing unit 56 is operated to pass through the moving image signal or the synthesized moving image signal when one moving image signal or one synthesized moving image signal is reconstructed by the one or more decompressing and decoding units 55a to 55n. The image synthesizing unit 56, on the other hand, is operated to synthesize more than one moving image signal or synthesized moving image signal to generate a synthesized moving image signal when more than one moving image signal or synthesized moving image signal is reconstructed by the one or more decompressing and decoding units 55a to 55n. Furthermore, the image synthesizing unit 56 is operated to pass through the sound signals decompressed and decoded by the one or more decompressing and decoding units 55a to 55n.

The data outputting unit 58 is operated to output the moving image signal passed through by the image synthesizing unit 56 when the image synthesizing unit 56 passes through the moving image signal. The data outputting unit 58, on the other hand, is operated to output the synthesized moving image signal synthesized by the image synthesizing unit 56 when the image synthesizing unit 56 generates the synthesized moving image signal. Furthermore, the data outputting unit 58 is operated to output the sound signals passed through by the image synthesizing unit 56.

The monitoring unit 51 is further provided with a speaker. The monitoring unit 51 is operated to display one moving picture on the screen when the moving image signal is outputted by the data outputting unit 58. The monitoring unit 51, on the other hand, is operated to display a plurality of moving pictures on the screen when the synthesized moving image signal is outputted by the data outputting unit 58. Furthermore, the monitoring unit 51 is operated to audibly output the sound signals outputted by the data outputting unit 58.

The image receiving apparatus 50 thus constructed can directly receive data portions including moving image signals and sound signals from the image transmission apparatus 20A to 20N, i.e., one or more image transmission apparatus, thereby making it possible for the image receiving apparatus 50 to directly receive the transmission data portions from one or more image transmission apparatus without passing through any relay system.

According to the present invention, the compressing and encoding unit 26 of the image transmission apparatus 20 is adapted to compress and encode the moving image signal in conformance with a commonly used compressing and encoding standard, and the decompressing and decoding units 55a to 55n of the image receiving apparatus 50 are adapted to decompress and decode the coded moving image signal data in conformance with the decompressing and decoding standard corresponding to the compressing and encoding standard which the compressing and encoding unit 26 is adapted to compress and encode in conformance with.

Description hereinlater will be directed to how the compressing and encoding unit 26 is operative to compress and encode the moving image signal or synthesized moving image signal and the sound signals to generate coded moving image signal data and coded sound signal data and the decompressing and decoding units 55a to 55m are operative to decompress and decode the coded moving image signal data and coded sound signal data to reconstruct the image signals and sound signals.

In the image transmission apparatus 20 according to the present invention, the compressing and encoding unit 26 may compress and encode the moving image signal or the synthesized moving image signal in conformance with a publicly-known compressing and encoding standard such as, for example, the “Moving Picture Expert Group Phase 1”, i.e., MPEG-1, “Moving Picture Expert Group Phase 2”, i.e., MPEG-2 or “Moving Picture Expert Group Phase 3”, i.e., MPEG-3 standard to generate coded moving image signal data. In the image receiving apparatus 50 according to the present invention, the one or more decompressing and decoding units 55a to 55n may decompress and decode the coded moving image signal data reconstructed by the one or more data receiving units 54a to 54n in conformance with corresponding decompressing and decoding standard of the MPEG-1, MPEG-2, or MPEG-3 standard to reconstruct a plurality of moving image signals.

In such a compressing and encoding system, the coded moving image signal data is outputted in the form of bit streams. In particular, the bit streams conformable to the above MPEG standard will be referred to as “MPEG bit streams” hereinlater. The above MPEG bit stream have a hierarchical structure consisting of: in turn, a top, sequence layer; a GROUP OF PICTURES layer; a picture layer; a slice layer; a macroblock layer, and a low, block layer.

The compressing and encoding unit 26 may be operative to compress and encode the moving image signal or the synthesized moving image signal under the MPEG standard through the steps of: (a) inputting a moving image signal or a synthesized moving image signal consisting of a series of pictures; (b) temporally storing the series of pictures as frames in memories, respectively; (c) computing a difference between one frame and another frame to eliminate redundancy in a time axis direction; and (d) orthogonal transforming, e.g., discrete cosine transforming (DCT), a plurality of picture elements within each of the frames to eliminate redundancy in a spatial axis direction.

The compressing and encoding unit 26 thus constructed can compress and encode the moving image signal or the synthesized moving image signal to generate and output a coded moving image signal data in the form of the MPEG bit stream. The coded moving image signal data is then transmitted from the compressing and encoding unit 26 to the decompressing and decoding units 55a to 55n which are operated to decompress and decode the coded moving image signal to reproduce the moving image signal or the synthesized moving image signal. Each of the decompressing and decoding units 55a to 55n is operative to decompress and decode the coded moving image signal data through a so-called bi-directionally predicting method which comprises the steps of:

(a) storing one reproduced picture, generally referred to as “intra-picture”, i.e., “I-picture”, in a first frame memory;

(b) estimating another picture generally referred to as “predictive-picture”, i.e., “P-picture”, followed by the I-picture, on the basis of the information on a difference between the I-picture and P-picture;

(c) storing the estimated P-picture in a second frame memory; and

(d) estimating further another picture interposed between the I-picture and P-picture, generally referred to as “bi-directionally predictive-picture”, i.e., “B-picture”.

Here, the I-picture is encoded independently of the pictures of the other types, so that an I-picture can be reproduced as a single static image only by itself. A P-picture can be predicted on the basis of the I-picture or another P-picture located on a position prior to the P-picture to be encoded. I-picture is referred to as “intra-picture” while P-picture and B-picture are referred to as “inter-pictures”.

In the image transmission and receiving system according to the present invention, the image transmission apparatus 20 can reliably transmit the transmission data portions to the image receiving apparatus 50.

In the image transmission apparatus 20 according to the present invention, the compressing and encoding unit 26 may compress and encode the moving image signal or the synthesized moving image signal in conformance with another compressing and encoding standard such as, for example, the ITU-T (International Telecommunication Union, Telecommunication Section) Recommendation H.261 standard or ITU-T Recommendation H.263 standard to generate coded moving image signal data. IN the image receiving apparatus 50 according to the present invention, the one or more decompressing and decoding units 55a to 55n may decompress and decode the coded moving image signal data reconstructed by the one or more data receiving units 54a to 54n in conformance with the corresponding decompressing and decoding standard of the ITU-T Recommendation H.261 standard or ITU-T Recommendation H.263 standard to reconstruct one or more moving image signals.

The ITU-T Recommendation H.261 standard and ITU-T (International Telecommunication Union, Telecommunication Section) Recommendation H.263 standard are adopted for use in ISDN (Integrated Services Digital Network), GSTN (General Switched Telephone Network), and low-speed LAN networks.

In the image transmission and receiving system according to the present invention, the image transmission apparatus 20 can reliably transmit the transmission data portions to the image receiving apparatus 50.

In the image transmission apparatus 20 according to the present invention, compressing and encoding unit 26 may compress and encode the moving image signal or the synthesized moving image signal in conformance with another compressing and encoding standard such as, for example, the JPEG or JPEG2000 standard to generate coded moving image signal data. In the image receiving apparatus 50 according to the present invention, the one or more decompressing and decoding units 55a to 55n may decompress and decode the coded moving image signal data in conformance with the corresponding standard of the JPEG or JPEG2000 standard to reconstruct one or more moving image signals.

The JPEG or JPEG2000 standard lags behind the MPEG standard in compression efficiency. The JPEG or JPEG2000 standard, however, has the advantage of facilitating the image data handling.

In the image transmission and receiving system according to the present invention, the image transmission apparatus 20 can reliably transmit the transmission data portions to the image receiving apparatus 50.

In the image transmission apparatus 20 according to the present invention, compressing and encoding unit 26 may compress and encode the sound signals in conformance with a publicly known sound compressing and encoding standard such as, for example, the MP3 (MPEG Audio Layer-3) or AAC (Advanced Audio Coding) standard to generate coded sound signal data. In the image receiving apparatus 50 according to the present invention, the one or more decompressing and decoding units 55a to 55n may decompress and decode the coded sound signal data in conformance with the corresponding sound decompressing and decoding standard of the MP3 or AAC standard to reconstruct one or more sound signals.

As will be seen from the foregoing description, it is to be understood that the image transmission apparatus 20, in the image transmission and receiving system thus constructed, can reliably transmit the transmission data portions including the moving image signals and sound signals to the image receiving apparatus 50.

The image transmission apparatus 20 according to the present invention is provided with a plurality of camera units 10a to 10e. The camera units 10a to 10e are similar in construction and function to one another. Description will be made on the camera units of the image transmission apparatus 20 according to the present invention.

Each of the camera unit 10a to 10e includes a camera portion, a driving unit, and an image processing circuit. The camera portion is positioned at a predetermined position and provided with a charged coupled device. The camera portion is adapted to take a moving picture at a predetermined shutter speed. The camera portion may be a Closed Circuit Television camera (CCTV) provided with a zoom function and a position present function. The driving unit is adapted to have the camera portion moved horizontally and vertically. The image processing circuit is adapted to convert the moving picture thus taken into moving image signal.

More specifically, from among the camera units 10a to 10e, only one camera unit is operative to take a moving picture of a respective object for a predetermined time period, for example, one second. Here, the moving picture is intended to mean a series of pictures consisting of a plurality of images taken for the predetermined time period. The camera units 10a to 10e may include various types of cameras such as, for example, a dome-shaped camera. The image inputting unit 21 includes a camera switching circuit, an analog to digital converter, and a memory buffer. The camera switching circuit is adapted to switch a camera unit 10i, which is one of the camera units 10a to 10e, operative to take a moving picture to another camera unit 10ᵢ₊₁ operative to take another moving picture at a predetermined interval, for example one second, in a predetermined order. Here, “i” and “i+1” are intended to mean any alphabet from “a” to “e”. The analog to digital converter is adapted to convert the moving picture taken by the camera unit into the moving image signal. The memory buffer is adapted to temporally store the moving image signal. The transmission control unit 24 is adapted to control the image inputting unit 21 in accordance with the line connection state information so as to input one moving picture taken by one camera unit 10i to be converted to one moving image signal or more than one moving picture taken by more than one camera unit to be converted to more than one moving image signal.

In the image transmission apparatus 20 and the image receiving apparatus 50 according to the present invention, the compressing and encoding unit 26 is adapted to compress and encode the moving image signal or synthesized moving image signal and the sound signals to generate coded moving image signal data and coded sound signal data, and the decompressing and decoding units 55a to 55m are adapted to decompress and decode the coded moving image signal data and coded sound signal data to reconstruct the moving image signal or synthesized moving image signal and the sound signals.

As will be seen from the foregoing description it is to be understood that the image transmission apparatus 20 or the image transmission apparatus 50, in the image transmitting and receiving system according to the present invention, can directly control a plurality of camera units located at a plurality of monitoring points, thereby making it possible to eliminate the need for any additional external control unit.

According to the present invention, the operation unit 52 of the image receiving apparatus 50 is operative to input an operation instruction by an operator. The receiving control unit 59 is operative to generate an operation request in accordance with the operation instruction. The image transmission apparatus 20 and the image receiving apparatus 50 are operative in accordance with the operation request. Description will now be made on the operation of the image receiving apparatus 50 and the image transmission apparatus 20 in accordance with the operation request.

It is assumed that the operation unit 52 is operated to input an operation instruction for specifying one image transmission apparatus 20 to establish and maintain a line connection with is inputted. The operation of the image receiving apparatus 50 and the image transmission apparatus 20 will be described hereinlater.

The operation unit 52 is operated to input an operation instruction by an operator for specifying one image transmission apparatus 20 to establish and maintain a line connection with, and controlling the image inputting unit 21 of the specified image transmission apparatus 20 to operate specified one or more camera units of said one or more camera units 10a to 10e to input one or more moving pictures. “The image transmission apparatus 20” is hereinlater referred to as any one of the image transmission apparatus 20A to 20N.

The receiving control unit 59 is then operated to generate an operation request in accordance with the operation instruction inputted by the operation unit 52. The receiving line connection control unit 53 is operated to receive the operation request generated by the receiving control unit 59, to identify the specified image transmission apparatus 20, to establish and maintain a line connection between the specified image transmission apparatus 20 and one of the data receiving units 54a to 54n in accordance with the operation request, and to transmit the operation request through the network to the specified image transmission apparatus 20.

In the specified image transmission apparatus 20, the transmission line connection control unit 23 is operated to generate the line connection state information in accordance with the operation request transmitted by the receiving line connection control unit 53 of the image receiving apparatus 50. The transmission control unit 24 is operated to input the line connection state information generated by the transmission line connection control unit 23, and to control the transmission line connection control unit 23 in accordance with the line connection state information so as to maintain a line connection between the image receiving apparatus 50 and the image transmission apparatus 20. The transmission control unit 24 is further operated to control the image inputting unit 21 in accordance with the line connection state information so that the image inputting unit 21 operate the specified one or more camera units of the one or more camera units 10a to 10e to input one or more moving pictures to be converted to one or more moving image signals. The transmission control unit 24 is further operated to control the image synthesizing unit 22 in accordance with the line connection state information so that the image synthesizing unit 22 passes through the moving image signal when one moving image signal is converted by the image inputting unit 21 and synthesizes more than one moving image signal to generate a synthesized moving image signal when more than one moving image signal is converted by the image inputting unit 21.

As will be seen from the foregoing description, it is to be understood the image receiving apparatus 50, in the image transmitting and receiving system thus constructed, can receive the transmission data portions from any one of a plurality of image transmission apparatus respectively located at a plurality of points to be monitored, thereby making it possible for the image receiving apparatus 50 to directly receive the transmission data portions from any one of the image transmission apparatus without passing through any relay system.

It is assumed that the operation unit 52 is operated to input an operation instruction for specifying one image transmission apparatus 20 to establish and maintain a line connection with, and specifying the positions of specified one or more camera units of the one or more camera units 10a to 10e operatively connected with the image inputting unit 21 of the specified image transmission apparatus 20. The operation of the image receiving apparatus 50 and the image transmission apparatus 20 will be described hereinlater.

The operation unit 52 is operated to input an operation instruction for specifying one image transmission apparatus 20 to establish and maintain a line connection with, and specifying the positions of specified one or more camera units of the one or more camera units 10a to 10e operatively connected with the image inputting unit 21 of the specified image transmission apparatus 20.

The receiving control unit 59 is operated to generate an operation request in accordance with the operation instruction inputted by the operation unit 52. The receiving line connection control unit 53 is operated to receive the operation request generated by the receiving control unit 59, to identify the specified image transmission apparatus 20, to establish and maintain a line connection between the specified image transmission apparatus 20 and one of the data receiving units 54a to 54n in accordance with the operation request, and to transmit the operation request through the network to the specified image transmission apparatus 20.

In the specified image transmission apparatus 20, the transmission line connection control unit 23 is operated to generate the line connection state information in accordance with the operation request transmitted by the receiving line connection control unit 53 of the image receiving apparatus 50. The transmission control unit 24 is operated to control the image inputting unit 21 in accordance with the line connection state information so that the image inputting unit 21 operates the specified one or more camera units of the one or more camera units 10a to 10e to drive one or more driving units of the specified one or more camera units of the one or more camera units 10a to 10e to have the camera portions of the specified one or more camera units of the one or more camera units 10a to 10e moved horizontally and vertically to the respective specified positions.

It is assumed that the operation unit 52 is operated to input a switching operation instruction for switching one image transmission apparatus, for example, the image transmission apparatus 20A to another image transmission apparatus, for example, the another image transmission apparatus 20B while the image transmission apparatus 20A maintains a line connection between the image transmission apparatus 20A and one of the data receiving units 54a to 54n of the image receiving apparatus 50. The operation of the image receiving apparatus 50 and the image transmission apparatus 20 will be described hereinlater.

The operation unit 52 is operated to input a switching operation instruction for switching one image transmission apparatus, for example, the image transmission apparatus 20A to another image transmission apparatus, for example, the another image transmission apparatus 20B while the image transmission apparatus 20A maintains a line connection between the image transmission apparatus 20A and one of the data receiving units 54a to 54n of the image receiving apparatus 50.

The operation unit 52 is operated to input a switching operation instruction for switching the image transmission apparatus 20A to another image transmission apparatus 20B while the image transmission apparatus 20A maintains a line connection between the image transmission apparatus 20A and one of the data receiving units 54a to 54n of the image receiving apparatus 50. The receiving control unit 59 is operated to generate a switching operation request in accordance with the switching operation instruction inputted by the operation unit 52.

The receiving line connection control unit 53 is operated to receive the switching operation request generated by the receiving control unit 59, to identify the another image transmission apparatus 20B, to disconnect a line connection between the image transmission apparatus 20A and the respective one of the data receiving units 54a to 54n if required, to establish and maintain another line connection between the another image transmission apparatus 20B and another one of the data receiving units 54a to 54n in accordance with the switching operation request, and to transmit the operation request through the network to the another image transmission apparatus 20B.

In the another image transmission apparatus 20B, the transmission line connection control unit 23 is operated to generate the line connection state information in accordance with the switching operation request transmitted by the receiving line connection control unit 53 of the image receiving apparatus 50.

The transmission control unit 24 is operated to input the line connection state information generated by the transmission line connection control unit 23, and to control the transmission line connection control unit 23 in accordance with the line connection state information so as to maintain a line connection between the image receiving apparatus 50 and the image transmission apparatus 20.

As will be seen from the foregoing description, it is to be understood that the image receiving apparatus and the image transmission apparatus, in the image transmitting and receiving system according to the present invention, can directly a plurality of camera units, thereby making it possible to eliminate the need for any additional external control unit.

As described hereinbefore, the configuration control unit 57 of the image receiving apparatus 50 to input configuration conditions to be stored therein. Description hereinlater will be made on the configuration control unit 57.

According to the present invention, the image receiving apparatus 50 may switch one image transmission apparatus from which transmission data portions are received to another image transmission apparatus at a predetermined time interval. The configuration conditions may include, for example, the time interval for which one image transmission apparatus, for example, the image transmission apparatus 20A is switched to another image transmission apparatus, for example, the another image transmission apparatus 20B, and a switching order in which the image transmission apparatus 20 is switched, for example, from the image transmission apparatus 20A, the image transmission apparatus 20B, the image transmission apparatus 20C, the image transmission apparatus 20D, the image transmission apparatus 20E, and the image transmission apparatus 20A.

It is assumed that the configuration control unit 57 is operated to input configuration conditions including a regular switching operation request at a time interval to be stored therein. The receiving control unit 59 is operated to generate a regular switching operation request at the time interval in the switching order in accordance with the configuration conditions stored in the configuration control unit 57.

According to the present invention, one or more data receiving units 54 to 54n of the image receiving apparatus 50 may correspond to the one or more image transmission apparatus 20A to 20N in one-to-one relationship while the one or more data receiving units 54 to 54n receive the one or more transmission data portions from the respective one or more transmission apparatus 20A to 20N.

It is assumed that the configuration conditions stored in the configuration control unit 57 include information about one-to-one relationship between the one or more data receiving units 54a to 54n and the one or more image transmission apparatus 20. The operation of the image receiving apparatus and the image transmission apparatus will be described hereinlater.

The configuration control unit 57 is operated to input configuration conditions including the information about one-to-one relationship between the one or more data receiving units 54a to 54n and the one or more image transmission apparatus 20.

The receiving control unit 59 is operated to generate a receiving operation request in accordance with the configuration conditions including the information about one-to-one relationship between the one or more data receiving units 54a to 54n and the one or more image transmission apparatus 20A to 20N stored in the configuration control unit 57.

The receiving line connection control unit 53 is operated to receive the receiving operation request generated by the receiving control unit 59, to identify the specified one or more image transmission apparatus 20A to 20N, to establish and maintain line connections between the specified image transmission apparatus 20A to 20N and the one or more data receiving units 54a to 54n each corresponding to respective one or more image transmission apparatus 20A to 20N in one-to-one relationship in accordance with the receiving operation request, and to transmit the operation request through the network to the specified image transmission apparatus 20.

The image receiving apparatus 50 and the other image receiving apparatus are adapted to receive the one or more transmission data portions at respective input bit rates. It is assumed that the configuration conditions stored in the configuration control unit 57 of the image receiving apparatus 50 include information about the input bit rate. The operation of the image receiving apparatus and the image transmission apparatus will be described hereinlater.

In the image receiving apparatus 50, the receiving control unit 59 is operated to generate a receiving operation request in accordance with the configuration conditions stored in the configuration control unit 57.

The receiving line connection control unit 53 is operated to receive the receiving operation request generated by the receiving control unit 59, to establish and maintain line connections between the specified image transmission apparatus 20 and the image receiving apparatus 50, and to transmit the receiving operation request through the network to the specified image transmission apparatus 20.

The transmission line connection control unit 23 is operated to generate the line connection state information in accordance with said operation request transmitted by the receiving line connection control unit 53.

The respective one of said one or more data transmitting units 27a to 27m is operated to generate one or more transmission data portions directed to the image receiving apparatus 50 at the input bit rate at which the image receiving apparatus 50 can receive the one or more transmission data portions.

As will be seen from the foregoing description, it is to be understood that the image receiving apparatus can reliably receive the transmission portions from the image transmitting apparatus without passing through any relay system.

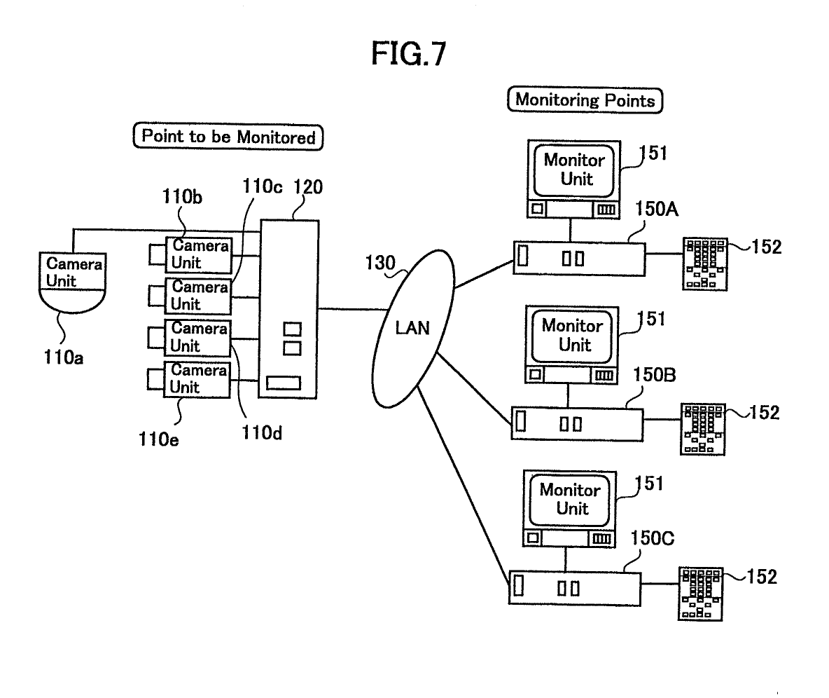

Referring to FIG. 7 of the drawings, there is shown a second embodiment of the image transmitting and receiving system according to the present invention. The second embodiment of the image transmitting and receiving system comprises one image transmission apparatus 120 including a plurality of camera units 110a to 110e and a plurality of image receiving apparatus 150A to 150C including respective monitor units 151 and operation units 152.

The image receiving apparatus 120 is similar in construction and function to the image receiving apparatus 20. Each of the image receiving apparatus 150A to 150C is similar construction and function to the image transmitting apparatus 50. The operation of the image receiving apparatus 120 and the image receiving apparatus 150A to 150C is similar to the operation of the image receiving apparatus 20 and the image transmission apparatus 50 and other image transmission apparatus. The image transmitting apparatus 120 located in a point to be monitored, in the image transmitting and receiving system according to the present invention, can transmit the transmission data portions to a plurality of image receiving apparatus 150A to 150C located at a plurality of monitoring points without passing through any relay system. Detailed description will be therefore omitted to avoid tedious repetition. The

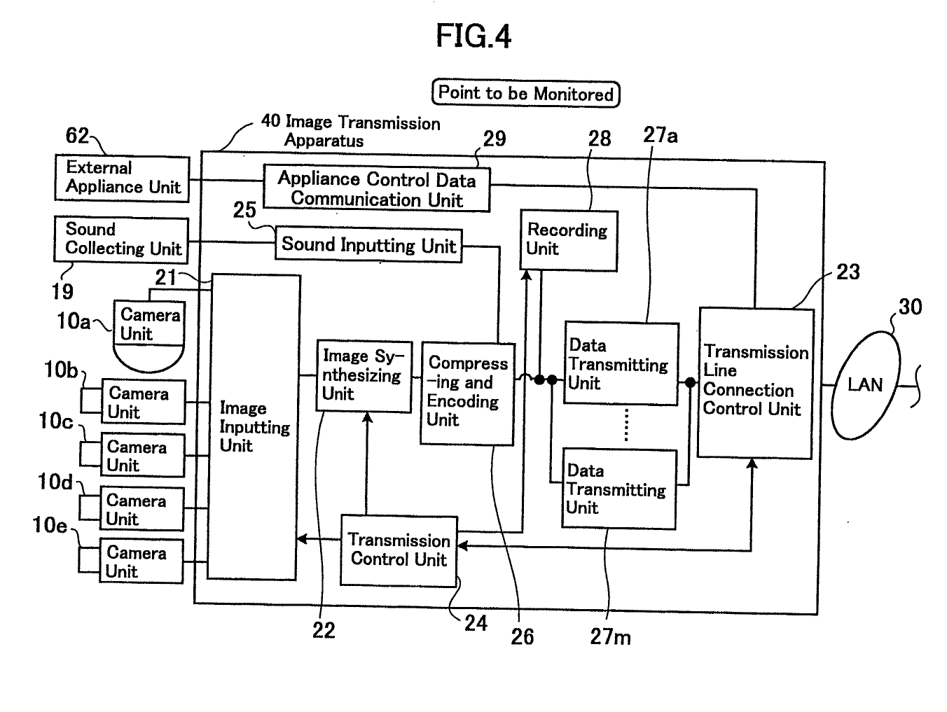

Referring then to FIG. 4 of the drawings, there is shown a modified embodiment of the image transmission apparatus 40. The image transmission apparatus 40 is similar in construction to the image transmission apparatus 20 and thus includes parts and elements the same in constitution and bearing numerical references the same as those of the image transmission apparatus 20 except for the fact that the image transmission apparatus 40 further comprises a recording unit 28, one or more external appliance units 62, and an appliance control data communication unit 29.

The recording unit 28 is adapted to temporally store the coded moving image signal data and coded sound signal data generated by the compressing and encoding unit 26 together with time information indicative of the time at which the coded moving image signal data arrives at the recording unit 28, event information indicative of the event type of the coded moving image signal data, and number information indicative of the number of the coded moving image signal data so that said coded moving image signal data and coded sound signal data are associated with the time information, event information and the number information.

The transmission control unit 24 is operated to control the recording unit 28 in accordance with the line connection state information generated by the transmission line connection control unit 23 with reference to the time information, the event information, and the number information.

According to the present invention, the image transmission apparatus 40 further includes one or more external appliance units 62 and an appliance control data communication unit 29 as shown in FIG. 4. The external appliance units 62 are adapted to output status control signals indicative of the state of respective external appliance units 62 located at respective points.

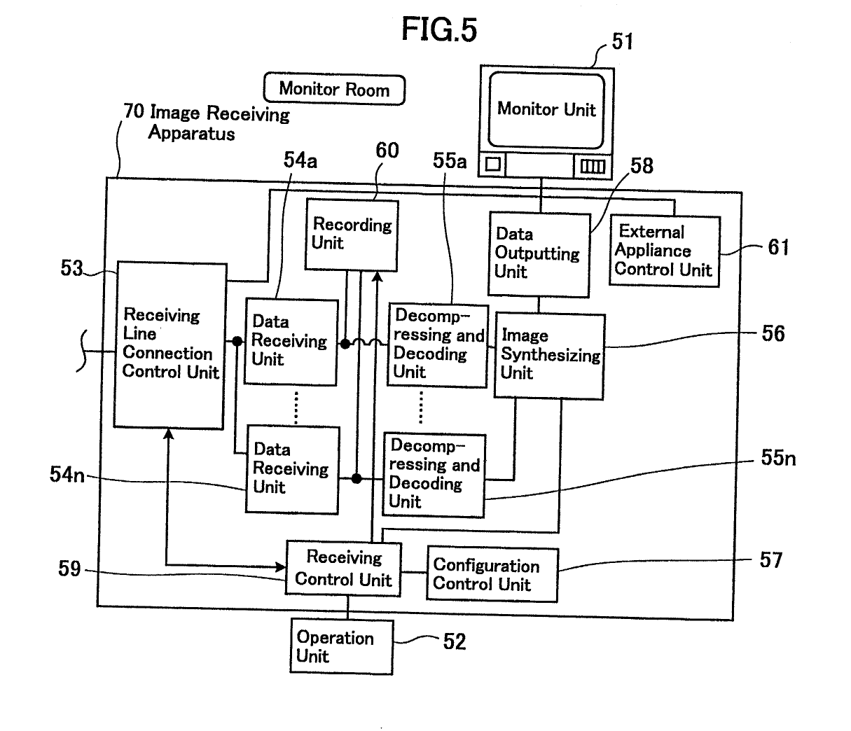

Referring then to FIG. 5 of the drawings, there is shown a modified embodiment of the image receiving apparatus 70. The image receiving apparatus 70 is similar in construction to the image receiving apparatus 50 and thus includes parts and elements the same in constitution and bearing numerical references the same as those of the image receiving apparatus 50 except for the fact that the image receiving apparatus 70 further comprises a recording unit 60, and an external appliance control unit 61.

The recording unit 60 is adapted to temporally input the coded moving image signal data and the coded sound signal data reconstructed by the one or more data receiving units 54a to 54n, and store the coded moving image signal data and the coded sound signal data in association with time information including a time at which the coded moving image signal data arrives at the recording unit 60, event information including an event type of the coded moving image signal data, and number information including a number of the coded moving image signal data in accordance with the operation instruction inputted by the operation unit 52.

The external appliance control unit 61 is adapted to input an external appliance operation instruction for operating specified one or more external appliance units 62 to generate an external appliance operation request.

The operation of the recording unit 60 will be described hereinlater.

The recording unit 60 is operated to temporally input the coded moving image signal data and the coded sound signal data reconstructed by the one or more data receiving units 54a to 54n, and store the coded moving image signal data and the coded sound signal data in association with time information including a time at which the coded moving image signal data arrives at the recording unit 60, event information including an event type of the coded moving image signal data, and number information including a number of the coded moving image signal data in accordance with the operation instruction inputted by the operation unit 52.

It is assumed that the operation unit 52 is operated to input, for example, a reproducing operation instruction for controlling the recording unit 60 to output the coded moving image signal data and the coded sound signal data stored therein. The operation unit 52 is operated to input a reproducing operation instruction for controlling the recording unit 60 to output the coded moving image signal data and the coded sound signal data stored therein. The receiving control unit 59 is operated to generate a reproducing operation request in accordance with the reproducing operation instruction inputted by the operation unit 52.

The recording unit 60 is operated to output the coded moving image signal data and coded sound signal data stored therein in accordance with the reproducing operation request generated by the receiving control unit 59. The one or more decompressing and decoding units 55a to 55n are operated to decompress and decode the coded moving image signal data and the coded sound signal data outputted by the recording unit 60 to reconstruct one or more synthesized moving image signals and sound signals.

It is assumed that the operation unit 52 is operated to input, for example, a searching operation instruction for searching a target coded moving image signal data and coded sound signal data with reference to a key information containing at least one of the time information, the event information and the number information as a key.

The receiving control unit 59 is operated to generate a searching operation request in accordance with the searching operation instruction inputted by the operation unit 52. The recording unit 60 is operated to search the target coded moving image signal data and coded sound signal data from among the coded moving image signal data and coded sound signal data stored in the recording unit 60 in accordance with the searching operation request including the key information by comparing the time information, the event information, and the number information associated with the coded moving image signal data and coded sound signal data with the key information to identify the target coded moving image signal data and coded sound signal data associated with at least one of the time information, the event information and the number information identical with the at least one of the time information, and to output the target coded moving image signal data and coded sound signal data.

As will be seen from the foregoing description, it is to be understood that the image receiving apparatus and the image transmission apparatus in the image transmitting and receiving system according to the present invention comprises storage units, thereby making it possible to store the coded moving image signal data or coded sound signal data directly in the image receiving apparatus or image transmission apparatus without being electrically connected with any additional external storage device.

According to the present invention, the image transmission apparatus 40 further includes an external appliance unit 62 and an appliance control data communication unit 29 as shown in FIG. 4. The external appliance unit 62 is adapted to output status control signals indicative of the state of the external appliance unit 62. The appliance control data communication unit 29 is adapted to transmit the status control signal outputted by the external appliance unit 62 to the transmission line connection control unit 23 of the image receiving apparatus 70 through the network 30 while the line connection between the image receiving apparatus 70 and the image transmission apparatus 40 is established and maintained. The external appliance control data communication unit 29 is adapted to generate and transmit an appliance control signal to the external appliance unit 62 in accordance with a line connection state information generated by the transmission line connection control unit 23. The external appliance unit 62 is operated in accordance with the respective appliance control signal generated by said appliance control data communication unit 29.

According to the present invention, the image transmission apparatus 40 may include a plurality of external appliance units 62 for respectively outputting more than one status control signal each indicative of the state of the external appliance unit 62.

Description hereinlater will be directed to the external appliance units 62 will be described.

The appliance control data communication unit 29 is operated to transmit a plurality of status control signals respectively outputted by the external appliance units 62 to the transmission line connection control unit 23, and to receive the line connection state information generated by the transmission line connection control unit 23 to generate a plurality of appliance control signals. The external appliance units 62 are respectively operated in accordance with the respective appliance control signals generated by the appliance control data communication unit 29.

The external appliance units 62 may include, for example, a matrix switcher, a frame switcher, and a recording device. The status control signals and appliance control signals that the appliance control data communication unit 29 receives from and transmits to the external appliance units 62 may include P.S. data (Matsushita specific control signal) and transparent serial data.

The external appliance control unit 61 is adapted to be used by an operator to input an external appliance operation instruction. The operation of the image transmission apparatus and the image receiving apparatus in response with the external control unit 61 will be described hereinlater.

The external appliance control unit 61 is operated to input, for example, an external appliance operation instruction for, for example, operating specified one or more external appliance units 62 of the image transmission apparatus 40 to generate an external appliance operation request.

The receiving line connection control unit 53 is operated to transmit the external appliance operation request generated by the external appliance control unit 61 through the network to the image transmission apparatus 40 when the receiving line connection control unit 53 maintains the line connection between the data receiving means 70 and the image transmission apparatus 40.

The transmission line connection control unit 23 of the image transmission apparatus 40 is operated to receive the external appliance operation request, and to generate a line connection state information in accordance with the external appliance operation request thus received. The appliance control data communication unit 29 is operated to receive the line connection state information generated by the transmission line connection control unit 23 to generate one or more appliance control signals. The specified one or more external appliance units 62 are operated to respectively operate in accordance with the one or more appliance control signals generated by the appliance control data communication unit 29.

The external appliance control unit 61 is operated to input, for example, an appliance status indicating instruction for displaying the status of specified one or more external appliance units 62. The one or more external appliance units 62 are operated to respectively output one or more status control signals each indicative of the state of the external appliance unit 62 including the type of the external appliance. The appliance control data communication unit 29 is operated to transmit the one or more status control signals respectively outputted by the one or more external appliance units 62 to the transmission line connection control unit 23.

The transmission line connection control unit 23 is operated to transmit the one or more status control signals through the network 30 to the image receiving apparatus 70 when the transmission line connection control unit 23 maintains the line connection between image transmission apparatus 40 and the data receiving means 70.

The receiving line connection control unit 53 of the image receiving apparatus 70 is operated to receive the one or more status control signals. The external appliance control unit 61 is operated to input the one or more status control signals received by the receiving line connection control unit 53, and to indicate the status of the specified one or more external appliance units 62 in accordance with the appliance status indicating instruction for displaying the status of the specified one or more external appliance units 62.

As will be seen from the foregoing description, it is to be understood that the image receiving apparatus and the image transmission apparatus in the image transmitting and receiving system according to the present invention can directly control the external appliances, thereby making it possible to eliminate the need for any additional external control unit.

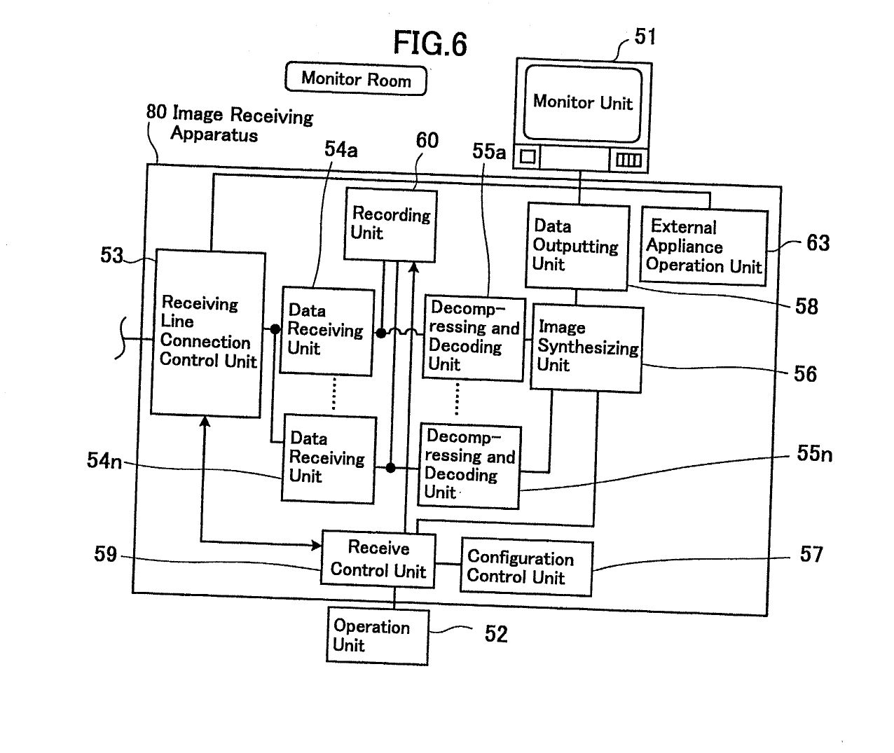

Referring to FIG. 6 of the drawings, there is shown a second modified embodiment of the image receiving apparatus 80. The image receiving apparatus 80 is similar in construction to the image receiving apparatus 70 and thus includes parts and elements the same in constitution and bearing numerical references the same as those of the image receiving apparatus 70 except for the fact that the external appliance control unit 61 is replaced by an external appliance operation unit 63.

In the image receiving apparatus 80 according to the present invention, the external appliance operation unit 63 may directly transmit a display instruction to the monitoring unit 51. Furthermore, the external appliance operation unit 63 is designed to be used by an operator to input an appliance operation instruction, which will be described later. A personal computer provided with a monitor may serve as the external appliance operation unit 63 and the monitoring unit 5 1.

The external appliance operation unit 63 is adapted input, for example, an appliance status displaying instruction for displaying the status of specified one or more external appliance units 62 and output the appliance status displaying instruction to the monitoring unit 51 to output the appliance status displaying instruction to the monitoring unit 51. The monitoring unit 51 is adapted to display the status of the specified one or more external appliance units 62 from among sad one or more external appliance units 62 in accordance with the appliance status displaying instruction

Description will be directed to the external appliance operation unit 63.

The external appliance operation unit 63 is operated to input, for example, an appliance status displaying instruction for displaying the status of specified one or more external appliance units 62 and output the appliance status displaying instruction to the monitoring unit 51. The monitoring unit 51 is operated to input the one or more status control signals respectively indicative of the status of the one or more external appliance units 62 received by the receiving line connection control unit 53, and to display the status of the specified one or more external appliance units 62 from among sad one or more external appliance units 62 in accordance with the appliance status displaying instruction outputted by the external appliance operation unit 63 when the receiving line connection control unit 53 maintains the line connection between the data receiving means 80 and the image transmission apparatus 40.

The external appliance operation unit 63 is operated to input, for example, an external appliance operation instruction for operating, for example, specified one or more external appliance units 62 while the monitoring unit 51 displays the status of the specified one or more external appliance units 62 while the receiving line connection control unit 53 maintains the line connection between the image receiving apparatus 80 and the image transmission apparatus 40.

The monitoring unit 51 is adapted to display the one or more moving pictures and the status of the specified one or more external appliance units 62 on the screen at the same time. The external appliance operation unit 63 is operated to input, for example, an external appliance operation instruction for operating specified one or more external appliance units 62 when the monitoring unit 51 displays the one or more moving pictures and the status of the specified one or more external appliance units 62 while the receiving line connection control unit 53 maintains the line connection between the data receiving means 80 and the image transmission apparatus 40.

The image inputting unit 21 of the image transmitting apparatus 40 is adapted to generate camera status information indicative of the status of the camera unit 10i. The operation unit 52 is operated to input, for example, a camera status display instruction for displaying the status of specified camera unit of specified image transmission apparatus 40.

The receiving control unit 59 is operated to generate a camera status display operation request in accordance with the camera status display instruction inputted by the operation unit 52. The receiving line connection control unit 53 is operated to transmit the camera status display operation request generated by the receiving control unit 59 to the specified image transmission apparatus 40 while the receiving line connection control unit 53 maintains the line connection between the data receiving means 80 and the specified image transmission apparatus 40.

The transmission line connection control unit 23 is operated to receive the camera status display operation request to be outputted to the image inputting unit 21 of the specified camera unit. The image inputting unit 21 is operated to generate the camera status information indicative of the status of the specified camera unit from among the camera units in accordance with the camera status display operation request outputted by the transmission line connection control unit 23. The transmission line connection control unit 23 is operated to transmit the camera status information to the receiving line connection control unit 53. The monitoring unit 51 is operated to display the status of the specified camera unit of the specified image transmission apparatus 40 in accordance with the camera status information.

According to the present invention, the camera unit 10 may further include a rotatable plate on which the camera portion is mounted. The rotatable plate is electrically connected with the image inputting unit 21. The transmission control unit 24 is adapted to control the image inputting unit 21 so as to rotate the camera portion to any one of a plurality of camera angles of the camera units to be designated by respective camera position numbers. The operation of how the camera position is stored in association with a camera position number designated by an operator will be described hereinlater.

The image inputting unit 21 may include a storage portion for storing the camera angles of the specified camera unit and camera position numbers. The status of the camera unit 10 may include all of camera angles of camera units and the camera position numbers. The operation unit 52 is operated by an operator to input, for example, a camera unit position number of specified image transmission apparatus 40 and a camera angle number storing instruction for storing the camera angle of a specified camera unit 10 so that the present camera angle of the specified image transmission apparatus 40 is stored with the camera unit position number just inputted.

The receiving control unit 59 is operated to generate a camera angle number storing operation request in accordance with the camera angle number storing instruction inputted by the operation unit 52. The receiving line connection control unit 53 is operated to transmit the camera angle number storing operation request generated by the receiving control unit 59 to the specified image transmission apparatus 40 when the receiving line connection control unit 53 maintains the line connection between the data receiving means 80 and the specified image transmission apparatus 40.

The transmission line connection control unit 23 is operated to receive the camera angle number storing operation request to be outputted to the image inputting unit 21 of the specified camera unit. The image inputting unit 21 is operated to store the present camera angle of the specified data transmission means 40 in association with the camera unit position number thus inputted in accordance with the camera angle number storing operation request outputted by the transmission line connection control unit 23.

The operation unit 52 is operated to input, for example, a camera unit position number of a specified data transmission means 40 and a camera angle number operation instruction for moving the camera angle of a specified camera unit 10 of the specified data transmission means 40 to the camera angle in association with sad camera unit position number thus inputted. The receiving control unit 59 is operated to generate a camera angle number operation request in accordance with the camera angle number operation instruction inputted by the operation unit 52.

The transmission control unit 24 is operated to control the image inputting unit 21 so as to rotate the camera portion to the camera angle of the specified camera unit in association with the camera unit position umber inputted by the operation unit 52.

As will be seen from the foregoing description, it is to be understood that the image receiving apparatus and the image transmitting apparatus in the image transmitting and receiving system according to the present invention can directly control a plurality of camera units and other external appliances located at a plurality of points.

Those skilled in the art having the benefit of the teachings of the present invention as hereinabove set forth, can effect numerous modifications thereto. These modifications are to be construed as being encompassed within the scope of the present invention as set forth in the appended claims.

What is claimed is:

1. An image transmitting and receiving system comprising:
a plurality of data transmission means each for transmitting one or more transmission data portions each generated as a result of compressing and encoding one or more moving image signals taken by respective camera units; and
one or more data receiving means each for receiving said one or more transmission data portions transmitted by said data transmission means through a network,
said data transmission means each including:
a plurality of camera units each for taking a moving picture of an object;
an image inputting unit operatively connected with said camera units for operating one or more said camera units to input one or more moving pictures taken by said one or more camera units to be converted to one or more moving image signals;
an image synthesizing unit for passing through said moving image signal when one moving image signal is converted by said image inputting unit and synthesizing more than one moving image signal to generate a synthesized moving image signal when more than one moving image signal is converted by said image inputting unit;
a compressing and encoding unit for compressing and encoding said moving image signal passed through by said image synthesizing unit when said image synthesizing unit passes through one moving image signal and compressing and encoding said synthesized moving image signal generated by said image synthesizing unit when said image synthesizing unit synthesizes more than one moving image signal to generate coded moving image signal data;
one or more data transmitting units for inputting said coded moving image signal data generated by said compressing and encoding unit, generating address information about said one or more data receiving means to which said coded moving image signal data is directed, and attaching address information about said one or more data receiving means to said coded moving image signal data to generate one or more transmission data portions directed to said respective one or more data receiving means;
a transmission line connection control unit for inputting said one or more transmission data portions generated by said one or more data transmitting units, establishing and maintaining one or more line connections between said one or more data transmitting units and respective one or more data receiving means in accordance with said address information attached in said one or more transmission data portions so as to transmit said one or more transmission data portions through said network to said respective one or more data receiving means, and generating line connection state information; and
a transmission control unit for controlling said image inputting unit, said image synthesizing unit, and said transmission line connection control unit in accordance with said line connection state information generated by said transmission line connection control unit;
said data receiving means each including:
a receiving line connection control unit for receiving said one or more transmission data portions transmitted by said respective one or more data transmission means;
one or more data receiving units for receiving said one or more transmission data portions to reconstruct coded moving image signal data, said receiving line connection control unit operative to establish and maintain one or more line connections between said one or more data receiving units and said respective one or more data transmission means in accordance with said address information attached in said one or more transmission data portions so as to receive said one or more transmission data portions through said network from said respective one or more data transmission means;
one or more decompressing and decoding units electrically connected with said respective one or more data receiving units in one-to-one relationship for decompressing and decoding said coded moving image signal data reconstructed by said respective one or more data receiving units to reconstruct one or more moving image signals or synthesized moving image signals;
an image synthesizing unit for passing through said moving image signal or said synthesized moving image signal when one moving image signal or one synthesized moving image signal is reconstructed by said one or more decompressing and decoding units and synthesizing more than one moving image signal or synthesized moving image signal to generate a synthesized moving image signal when more than one moving image signal or synthesized moving image signal is reconstructed by said one or more decompressing and decoding units;
a data outputting unit for outputting said moving image signal or said synthesized moving image signal passed through by said image synthesizing unit when said image synthesizing unit passes through said moving image signal or said synthesized moving image signal, and outputting said synthesized moving image signal synthesized by said image synthesizing unit when said image synthesizing unit generates said synthesized moving image signal;
a monitoring unit having a screen for displaying one moving picture on said screen when said moving image signal is outputted by said data outputting unit, and displaying a plurality of moving pictures on said screen when said synthesized moving image signal is outputted by said data outputting unit;
an operation unit for inputting an operation instruction therethrough; and
a receiving control unit for generating an operation request in accordance with said operation instruction inputted by said operation unit, controlling said receiving line connection control unit in accordance with said operation request and said one or more transmission data portions transmitted by said respective one or more data transmission means.

2. An image transmitting and receiving system as set forth in claim 1, in which said data transmission means further includes:
a sound collecting unit for collecting sounds to be converted into sound signals; and
a sound inputting unit for inputting said sound signals converted by said sound collecting unit;
said compressing and encoding unit is operative to compress and encode said synthesized moving image signal synthesized by said image synthesizing unit and said sound signals inputted by said sound inputting unit to generate coded moving image signal data and coded sound signal data;
said one or more data transmitting units are operative to input said coded moving image signal data and said coded sound data generated by said compressing and encoding unit, to generate address information about said one or more data receiving means to which said coded moving image signal data and said coded sound signal data are directed, and to attach said address information about said one or more data receiving means to said coded moving image signal data and said coded sound data to generate one or more transmission data portions directed to said respective one or more data receiving means,
said one or more data receiving units are operative to receive said one or more transmission data portions to reconstruct said coded moving image signal data and said coded sound signal data;
said one or more decompressing and decoding units are operative to decompress and decode said coded moving image signal data and said coded sound signal data reconstructed by said one or more data receiving units to reconstruct one or more synthesized moving image signals and sound signals;
said image synthesizing unit is operative to pass through said moving image signal or said synthesized moving image signal when one moving image signal or one synthesized moving image signal is reconstructed by said one or more decompressing and decoding units, and to synthesize more than one moving image signal or synthesized moving image signal to generate a synthesized moving image signal when more than one moving image signal or synthesized moving image signal is reconstructed by said one or more decompressing and decoding units, and to pass through said sound signals decompressed and decoded by said one or more decompressing and decoding units
said data outputting unit is operative to output said moving image signal passed through by said image synthesizing unit when said image synthesizing unit passes through said moving image signal, and to output said synthesized moving image signal synthesized by said image synthesizing unit when said image synthesizing unit generates said synthesized moving image signal, and to output said sound signals passed through by said image synthesizing unit; and
said monitoring unit is further provided with a speaker and operative to display one moving picture on said screen when said moving image signal is outputted by said data outputting unit, and to display a plurality of moving pictures on said screen when said synthesized moving image signal is outputted by said data outputting unit, and to audibly output said sound signals outputted by said data outputting unit.

3. An image transmitting and receiving system as set forth in claim 2, in which said camera unit includes a camera portion positioned at a predetermined position and provided with a charged coupled device for taking a moving picture at a predetermined shutter speed, a driving unit for having said camera portion moved horizontally and vertically, and an image processing circuit for converting said moving picture into moving image signal.

4. An image transmitting and receiving system as set forth in claim 3, in which one of said camera units is operative to take a moving picture of a respective object at a time, said image inputting unit includes a camera switching circuit for switching one of said camera units operative to take a moving picture to another camera unit operative to take another moving picture at a predetermined interval in a predetermined order, an analog to digital converter for converting said moving picture taken by said camera unit into said moving image signal, and a memory buffer for temporally storing said moving image signal, and said transmission control unit is operative to control said image inputting unit in accordance with said line connection state information so as to input one moving picture taken by one camera unit to be converted to one moving image signal or more than one moving picture taken by more than one camera unit to be converted to more than one moving image signal.

5. An image transmitting and receiving system as set forth in claim 2, in which said address information includes addresses of more than one data receiving means, and one of said one or more data transmitting units is operative to attach said address information about said more than one data receiving means to said coded moving image signal data generated by said compressing and encoding unit to generate one or more transmission data portion each directed to said more than one data receiving means, said transmission line connection control unit is operative to input said one or more transmission data portions generated by said one of said one or more data transmitting units, establishing and maintaining one or more line connections between said one of said one or more data transmitting units and respective one or more data receiving means in accordance with said address information attached in said one or more transmission data portions so as to transmit said one or more transmission data portions through said network to said respective one or more data receiving means.

6. An image transmitting and receiving system as set forth in claim 5, in which said operation unit is operative to input an operation instruction for specifying one data transmission means to establish and maintain a line connection with, and controlling said image inputting unit of said specified data transmission means to operate specified one or more camera units of said one or more camera units to input one or more moving pictures, said receiving control unit is operative to generate an operation request in accordance with said operation instruction inputted by said operation unit, said receiving line connection control unit is operative to receive said operation request generated by said receiving control unit, to identify said specified data transmission means, to establish and maintain a line connection between said specified data transmission means and one of said data receiving units in accordance with said operation request, and to transmit said operation request through said network to said specified data transmission means, said transmission line connection control unit of said specified data transmission means is operative to generate said line connection state information in accordance with said operation request transmitted by said receiving line connection control unit of said data receiving means, said transmission control unit is operative to input said line connection state information generated by said transmission line connection control unit, and to control said transmission line connection control unit in accordance with said line connection state information so as to maintain a line connection between said data receiving means and said data transmission means, said transmission control unit is further operative to control said image inputting unit in accordance with said line connection state information so that said image inputting unit operate said specified one or more camera units of said one or more camera units to input one or more moving pictures to be converted to one or more moving image signals, and said transmission control unit is further operative to control said image synthesizing unit in accordance with said line connection state information so that said image synthesizing unit passes through said moving image signal when one moving image signal is converted by said image inputting unit and synthesizes more than one moving image signal to generate a synthesized moving image signal when more than one moving image signal is converted by said image inputting unit.

7. An image transmitting and receiving system as set forth in claim 6, in which said operation unit is operative to input an operation instruction for specifying one data transmission means to establish and maintain a line connection with, and specifying positions of specified one or more camera units of said one or more camera units operatively connected with said image inputting unit of specified data transmission means, said receiving control unit is operative to generate an operation request in accordance with said operation instruction inputted by said operation unit, said receiving line connection control unit is operative to receive said operation request generated by said receiving control unit, to identify said specified data transmission means, to establish and maintain a line connection between said specified data transmission means and one of said data receiving units in accordance with said operation request, and to transmit said operation request through said network to said specified data transmission means, and said transmission control unit is operative to control said image inputting unit in accordance with said line connection state information so that said image inputting unit operates said specified one or more camera units of said one or more camera units to drive one or more driving units of said specified one or more camera units of said one or more camera units to have said camera portions of said specified one or more camera units of said one or more camera units moved horizontally and vertically to said respective specified positions.

8. An image transmitting and receiving system as set forth in claim 6, in which said operation unit is operative to input a switching operation instruction for switching said data transmission means to another data transmission means while said data transmission means maintains a line connection between said data transmission means and one of said data receiving units of said data receiving means, said receiving control unit is operative to generate a switching operation request in accordance with said switching operation instruction inputted by said operation unit, said receiving line connection control unit is operative to receive said switching operation request generated by said receiving control unit, to disconnect a line connection between said data transmission means and the respective one of the data receiving units if required, to identify said another data transmission means, to establish and maintain another line connection between said another data transmission means and another one of said data receiving units in accordance with said switching operation request, and to transmit said operation request through said network to said another data transmission means, said transmission line connection control unit of said another data transmission means is operative to generate said line connection state information in accordance with said switching operation request transmitted by said receiving line connection control unit of said data receiving means, and said transmission control unit is operative to input said line connection state information generated by said transmission line connection control unit, and to control said transmission line connection control unit in accordance with said line connection state information so as to maintain a line connection between said data receiving means and said data transmission means.

9. An image transmitting and receiving system as set forth in claim 8, in which said data receiving means further includes a configuration control unit having a configuration storage portion for inputting configuration conditions to be stored therein, said configuration conditions include a time interval for which one data transmission means is switched to another data transmission means, and a switching order in which said data transmission means is switched, and said receiving control unit is operative to generate a regular switching operation request at said time interval in said switching order in accordance with said configuration conditions stored in said configuration control unit.

10. An image transmitting and receiving system as set forth in claim 1, in which said data receiving means further includes a configuration control unit having a configuration storage portion for inputting configuration conditions to be stored therein, said configuration conditions include information about one-to-one relationship between said one or more data receiving units and said one or more data transmission means, said receiving control unit is operative to generate a receiving operation request in accordance with said configuration conditions stored in said configuration control unit, said receiving line connection control unit is operative to receive said receiving operation request generated by said receiving control unit, to identify said specified one or more data transmission means, to establish and maintain line connections between said specified data transmission means and said one or more data receiving units each corresponding to respective one or more data transmission means in one-to-one relationship in accordance with said receiving operation request, and to transmit said operation request through said network to said specified data transmission means, said transmission line connection control unit of said specified data transmission means is operative to generate said line connection state information in accordance with said receiving operation request transmitted by said receiving line connection control unit of said data receiving means, and said transmission control unit is operative to input said line connection state information generated by said transmission line connection control unit, and to control said transmission line connection control unit in accordance with said line connection state information so as to maintain line connections between said data receiving means and said respective one or more data receiving units.

11. An image transmitting and receiving system as set forth in claim 10, in which said one or more data receiving means are operative to receive said one or more transmission data portions at respective input bit rates, said configuration conditions include information about said input bit rate, said receiving control unit of said data receiving means is operative to generate a receiving operation request in accordance with said configuration conditions stored in said configuration control unit, said receiving line connection control unit is operative to receive said receiving operation request generated by said receiving control unit, to establish and maintain line connections between said specified data transmission means and said data receiving means, and to transmit said receiving operation request through said network to said specified data transmission means, said transmission line connection control unit is operative to generate said line connection state information in accordance with said operation request transmitted by the receiving line connection control unit, and said respective one of said one or more data transmitting units is operative to generate one or more transmission data portions directed to said data receiving means at said input bit rate.

12. An image transmitting and receiving system as set forth in claim 1, in which said data receiving means is operative to receive one or more transmission data portions transmitted by another data transmission means, and said receiving line connection control unit of said data receiving means is operative to establish and maintain another line connection between another one of said data receiving units and said another data transmission means in response to said one or more transmission data portions transmitted by another data transmission means, while said data receiving means maintains a line connection between said data receiving means and one data transmission means, and said receiving line connection control unit maintains a line connection between one of said data receiving units and said data transmission means.

13. An image transmitting and receiving system as set forth in claim 1, in which while said data transmission means maintains a line connection between said data receiving means and said data transmission means, and said transmission line connection control unit maintains a line connection between one of said data transmitting units and said data receiving means so as to transmit said one or more transmission data portions generated by said one of said data transmitting units to said data receiving means, said data transmission means is operative to transmit one or more transmission data portions to another data receiving means, said transmission line connection control unit of said data transmission means is operative to establish and maintain another line connection between said another data receiving means and another one of said data transmitting units so as to transmit said one or more transmission data portions to said another data receiving means, and said receiving line connection control unit of said another data receiving means is operative to establish and maintain said line connection between one of said data receiving units and said data transmission means to receive said one or more transmission data portions transmitted by said data transmission means.

14. An image transmitting and receiving system as set forth in claim 1, in which when a line connection between data transmission means and data receiving means is disconnected while one of said data transmitting units is transmitting one or more transmission data portions through said network to said data receiving means, said transmission line connection control unit is operative to restore and maintain said line connection between one of said data transmitting units and said data receiving means so as to transmit said one or more transmission data portions generated by said one of said data transmitting units through said network to said data receiving means, said receiving line connection control unit is operative to restore and maintain said line connection between one of said data receiving units and said data transmission means to receive said one or more transmission data portions transmitted by said data transmission means.

15. An image transmitting and receiving system as set forth in claim 1, in which said compressing and encoding unit is operative to compress and encode said moving image signal passed through by said image synthesizing unit when one moving image signal is converted by said image inputting unit and said synthesized moving image signal generated by said image synthesizing unit when more than one moving image signal is converted by said image inputting unit in conformance with the ITU-T Recommendation H.261 standard or ITU-T Recommendation H.263 standard to generate coded moving image signal data, and said one or more decompressing and decoding units are operative to decompress and decode said coded moving image signal data reconstructed by said one or more data receiving units in conformance with the ITU-T Recommendation H.261 standard or ITU-T Recommendation H.263 standard to reconstruct one or more moving image signals.

16. An image transmitting and receiving system as set forth in claim 1, in which said compressing and encoding unit is operative to compress and encode said moving image signal passed through by said image synthesizing unit when one moving image signal is converted by said image inputting unit and said synthesized moving image signal generated by said image synthesizing unit when more than one moving image signal is converted by said image inputting unit in conformance with the MPEG-1, MPEG-2 or MPEG-3 standard to generate coded moving image signal data, and said one or more decompressing and decoding units are operative to decompress and decode said coded moving image signal data reconstructed by said one or more data receiving units in conformance with the MPEG-1, MPEG-2, or MPEG-3 standard to reconstruct one or more moving image signals.

17. An image transmitting and receiving system as set forth in claim 1, in which said compressing and encoding unit is operative to compress and encode said moving image signal passed through by said image synthesizing unit when one moving image signal is converted by said image inputting unit and said synthesized moving image signal generated by said image synthesizing unit when more than one moving image signal is converted by said image inputting unit in conformance with the JPEG or JPEG2000 standard to generate coded moving image signal data, and said one or more decompressing and decoding units is operative to decompress and decode said coded moving image signal data reconstructed by said one or more data receiving units in conformance with the JPEG or JPEG2000 standard to reconstruct one or more moving image signals.

18. An image transmitting and receiving system as set forth in claim 2, in which said data transmission means further includes a recording unit for temporally storing said coded moving image signal data and coded sound signal data generated by said compressing and encoding unit together with time information indicative of the time at which said coded moving image signal data arrives at said recording unit, event information indicative of the event type of said coded moving image signal data, and number information indicative of the number of said coded moving image signal data so that said coded-moving image signal data and coded sound signal data are associated with said time information, said event information and said number information, said transmission control unit is operative to control said recording unit in accordance with said line connection state information generated by said transmission line connection control unit with reference to said time information, said event information, and said number information.

19. An image transmitting and receiving system as set forth in claim 2, in which said data receiving means further includes a recording unit for temporally inputting said coded moving image signal data and said coded sound signal data reconstructed by said one or more data receiving units, and storing said coded moving image signal data and said coded sound signal data in association with time information including a time at which said coded moving image signal data arrives at said recording unit, event information including an event type of said coded moving image signal data, and number information including a number of said coded moving image signal data in accordance with said operation instruction inputted by said operation unit.

20. An image transmitting and receiving system as set forth in claim 19, in which said operation unit is operative to input a synthesizing operation instruction for synthesizing specified moving image signals or synthesized moving image signals for said image synthesizing unit, said receiving control unit is operative to generate a synthesizing operation request in accordance with said synthesizing operation instruction inputted by said operation unit, and said image synthesizing unit is operative to select specified moving image signals or synthesized moving image signals from among said moving image signals or synthesized moving image signals reconstructed by said one or more decompressing and decoding units in accordance with said synthesizing operation request generated by said receiving control unit and synthesizing said specified moving image signal or synthesized moving image signal to generate a synthesized moving image signal when said moving image signals or synthesized moving image signals are reconstructed by said one or more decompressing and decoding units.

21. An image transmitting and receiving system as set forth in claim 20, in which said operation unit is operative to input a reproducing operation instruction for controlling said recording unit to output said coded moving image signal data and said coded sound signal data stored therein, said receiving control unit is operative to generate a reproducing operation request in accordance with said reproducing operation instruction inputted by said operation unit, said recording unit is operative to output said coded moving image signal data and coded sound signal data stored therein in accordance with said reproducing operation request generated by said receiving control unit, and said one or more decompressing and decoding units are operative to decompress and decode said coded moving image signal data and said coded sound signal data outputted by said recording unit to reconstruct one or more synthesized moving image signals and sound signals.

22. An image transmitting and receiving system as set forth in claim 21, in which said operation unit is operative to input a searching operation instruction for searching a target coded moving image signal data and coded sound signal data with a key information containing at least one of said time information, said event information and said number information, said receiving control unit is operative to generate a searching operation request in accordance with said searching operation instruction inputted by said operation unit, and said recording unit is operative to search said target coded moving image signal data and coded sound signal data from among said coded moving image signal data and coded sound signal data stored in said recording unit in accordance with said searching operation request including said key information by comparing said time information, said event information, and said number information associated with said coded moving image signal data and coded sound signal data with said key information to identify said target coded moving image signal data and coded sound signal data associated with at least one of said time information, said event information and said number information identical with said at least one of said time information, and to output said target coded moving image signal data and coded sound signal data.

23. An image transmitting and receiving system as set forth in claim 22, in which said data transmission means further includes an external appliance unit for outputting a status control signal indicative of the state of said external appliance unit, and an appliance control data communication unit for transmitting said status control signal outputted by said external appliance unit to said transmission line connection control unit of said data receiving means through said network while said line connection between said data transmission means and said data receiving means is established and maintained, and said external appliance control data communication unit is operative to generate and transmit appliance control signal to the external appliance unit in accordance with a line connection state information generated by said transmission line connection control unit, and said external appliance unit is operative to operate in accordance with said respective appliance control signal generated by said appliance control data communication unit.

24. An image transmitting and receiving system as set forth in claim 23, in which said data transmission means includes a plurality of external appliance units for respectively outputting a plurality of status control signals each indicative of the state of said external appliance unit, said appliance control data communication unit is operative to transmit said status control signals respectively outputted by said external appliance units to said transmission line connection control unit, and to receive said line connection state information generated by said transmission line connection control unit to generate a plurality of appliance control signals, and said external appliance units being operative to respectively operate in accordance with said appliance control signals generated by said appliance control data communication unit.

25. An image transmitting and receiving system as set forth in claim 24, in which said data receiving means further includes an external appliance control unit for inputting an external appliance operation instruction for operating specified one or more external appliance units of said data transmission means to generate an external appliance operation request, said receiving line connection control unit is operative to transmit said external appliance operation request generated by said external appliance control unit through said network to said data transmission means when said receiving line connection control unit maintains said line connection between said data receiving means and said data transmission means, said transmission line connection control unit of said data transmission means is operative to receive said external appliance operation request, and to generate a line connection state information in accordance with said external appliance operation request thus received, and said appliance control data communication unit is operative to receive said line connection state information generated by said transmission line connection control unit to generate one or more appliance control signals, said specified one or more external appliance units are operative to respectively operate in accordance with said one or more appliance control signals generated by said appliance control data communication unit.

26. An image transmitting and receiving system as set forth in claim 25, in which said external appliance control unit is operative to input an appliance status indicating instruction for displaying the status of specified one or more external appliance units, said one or more external appliance units are operative to respectively output one or more status control signals each indicative of the state of said external appliance unit including the type of said external appliance, said appliance control data communication unit is operative to transmit said one or more status control signals respectively outputted by said one or more external appliance units to said transmission line connection control unit, said transmission line connection control unit is operative to transmit said one or more status control signals through said network to said data receiving means when said transmission line connection control unit maintains said line connection between data transmission means and said data receiving means, said receiving line connection control unit of said data receiving means is operative to receive said one or more status control signals, and said external appliance control unit is operative to input said one or more status control signals received by said receiving line connection control unit, and to indicate the status of said specified one or more external appliance units in accordance with said appliance status indicating instruction for displaying the status of specified one or more external appliance units.

27. An image transmitting and receiving system as set forth in claim 26, in which said external appliance control unit is operated to input an appliance status displaying instruction for displaying the status of specified one or more external appliance units and output said appliance status displaying instruction to said monitoring unit, and said monitoring unit is operative to input said one or more status control signals respectively indicative of the status of said one or more external appliance units received by said receiving line connection control unit, and to display the status of said specified one or more external appliance units from among sad one or more external appliance units in accordance with said appliance status displaying instruction outputted by said external appliance control unit when said receiving line connection control unit maintains said line connection between said data receiving means and said data transmission means.

28. An image transmitting and receiving system as set forth in claim 27, in which said external appliance control unit is operative to input an external appliance operation instruction for operating specified one or more external appliance units when said monitoring unit displays the status of said specified one or more external appliance units while said receiving line connection control unit maintains said line connection between said data receiving means and said data transmission means.

29. An image transmitting and receiving system as set forth in claim 28, in which said monitoring unit is operative to display said one or more moving pictures and the status of said specified one or more external appliance units on said screen at the same time.

30. An image transmitting and receiving system as set forth in claim 29, in which said external appliance control unit is operative to input an external appliance operation instruction for operating specified one or more external appliance units when said monitoring unit displays said one or more moving pictures and the status of said specified one or more external appliance units while said receiving line connection control unit maintains said line connection between said data receiving means and said data transmission means.

31. An image transmitting and receiving system as set forth in claim 29, in which said image inputting unit of said data transmission means is operative to generate camera status information indicative of the status of said camera unit, said operation unit is operative to input a camera status display instruction for displaying the status of specified camera unit of specified data transmission means, said receiving control unit is operative to generate a camera status display operation request in accordance with said camera status display instruction inputted by said operation unit, said receiving line connection control unit is operative to transmit said camera status display operation request generated by said receiving control unit to said specified data transmission means while said receiving line connection control unit maintains said line connection between said data receiving means and said specified data transmission means, said transmission line connection unit is operative to receive said camera status display operation request to be outputted to said image inputting unit of said specified camera unit, said image inputting unit is operative to generate said camera status information indicative of the status of said specified camera unit from said camera units in accordance with said camera status display operation request outputted by said transmission line connection unit, and said transmission line connection unit is operative to transmit said camera status information to said receiving line connection control unit, and said monitoring unit is operative to display said status of said specified camera unit of said specified data transmission means in accordance with said camera status information.

32. An image transmitting and receiving system as set forth in claim 31, in which said camera unit further includes a rotatable plate on which said camera portion is mounted, said rotatable plate is electrically connected with said image inputting unit, said transmission control unit is operative to control said image inputting unit so as to rotate said camera portion to any one of a plurality of camera angles of camera units in association with respective camera unit position numbers, said image inputting unit includes a storage portion for storing said camera angles of a specified camera unit and camera unit position numbers, the status of said camera unit includes all of camera angles of camera units and said camera unit position numbers, whereby said operation unit is operative to input a camera unit position number of a specified data transmission means and a camera angle number storing instruction for storing said camera angle of said specified camera unit so as to store the present camera angle of said specified camera unit of said specified data transmission means in association with said camera unit position number thus inputted, said receiving control unit is operative to generate a camera angle number storing operation request in accordance with said camera angle number storing instruction inputted by said operation unit, said receiving line connection control unit is operative to transmit said camera angle number storing operation request generated by said receiving control unit to said specified data transmission means while said receiving line connection control unit maintains said line connection between said data receiving means and said specified data transmission means, said transmission line connection unit is operative to receive said camera angle number storing operation request to be outputted to said image inputting unit of said specified camera unit, and said image inputting unit is operative to store the present camera angle of said specified data transmission means in association with said camera unit position number thus inputted in accordance with said camera angle number storing operation request outputted by said transmission line connection unit.

33. An image transmitting and receiving system as set forth in claim 32, in which said operation unit is operative to input a camera unit position number of a specified data transmission means and a camera angle number operation instruction for moving said camera angle of said specified data transmission means to said camera angle in association with sad camera unit position number thus inputted, said receiving control unit is operative to generate a camera angle number operation request in accordance with said camera angle number operation instruction inputted by said operation unit, and said transmission control unit is operative to control said image inputting unit so as to rotate said camera portion of said specified camera unit to said camera angle in association with said camera unit position umber inputted by said operation unit.

34. An image transmission apparatus for transmitting one or more transmission data portions each generated as a result of compressing and encoding one or more moving image signals taken by respective camera units comprising:
a plurality of camera units each for taking a moving picture of an object;
an image inputting unit operatively connected with said camera units for operating one or more said camera units to input one or more moving pictures taken by said one or more camera units to be converted to one or more moving image signals;
an image synthesizing unit for passing through said moving image signal when one moving image signal is converted by said image inputting unit and synthesizing more than one moving image signal to generate a synthesized moving image signal when more than one moving image signal is converted by said image inputting unit;
a compressing and encoding unit for compressing and encoding said moving image signal passed through by said image synthesizing unit when said image synthesizing unit passes through one moving image signal and compressing and encoding said synthesized moving image signal generated by said image synthesizing unit when said image synthesizing unit synthesizes more than one moving image signal to generate coded moving image signal data;
one or more data transmitting units for inputting said coded moving image signal data generated by said compressing and encoding unit, generating address information about one or more image receiving apparatus to which said coded moving image signal data is directed, and attaching address information about said one or more image receiving apparatus to said coded moving image signal data to generate one or more transmission data portions directed to said respective one or more image receiving apparatus;
a transmission line connection control unit for inputting said one or more transmission data portions generated by said one or more data transmitting units, establishing and maintaining one or more line connections between said one or more data transmitting units and respective one or more image receiving apparatus in accordance with said address information attached in said one or more transmission data portions so as to transmit said one or more transmission data portions through said network to said respective one or more image receiving apparatus, and generating line connection state information; and
a transmission control unit for controlling said image inputting unit, said image synthesizing unit, and said transmission line connection control unit in accordance with said line connection state information generated by said transmission line connection control unit.

35. An image receiving apparatus for receiving said one or more transmission data portions transmitted by one or more image transmission apparatus through a network comprising:
a receiving line connection control unit for receiving said one or more transmission data portions transmitted by said respective one or more image transmission apparatus;
one or more data receiving units for receiving said one or more transmission data portions to reconstruct coded moving image signal data, said receiving line connection control unit operative to establish and maintain one or more line connections between said one or mote data receiving units and said respective one or more image transmission apparatus in accordance with said address information attached in said one or more transmission data portions so as to receive said one or more transmission data portions through said network from said respective one or more image transmission apparatus;
one or more decompressing and decoding units electrically connected with said respective one or more data receiving units in one-to-one relationship for decompressing and decoding said coded moving image signal data reconstructed by said respective one or more data receiving units to reconstruct one or more moving image signals or synthesized moving image signals,
an image synthesizing unit for passing through said moving image signal or said synthesized moving image signal when one moving image signal or one synthesized moving image signal is reconstructed by said one or more decompressing and decoding units and synthesizing more than one moving image signal or synthesized moving image signal to generate a synthesized moving image signal when more than one moving image signal or synthesized moving image signal is reconstructed by said one or more decompressing and decoding units;
a data outputting unit for outputting said moving image signal or said synthesized moving image signal passed through by said image synthesizing unit when said image synthesizing unit passes through said moving image signal or said synthesized moving image signal, and outputting said synthesized moving image signal synthesized by said image synthesizing unit when said image synthesizing unit generates said synthesized moving image signal;
a monitoring unit having a screen for displaying one moving picture on said screen when said moving image signal is outputted by said data outputting unit, and displaying a plurality of moving pictures on said screen when said synthesized moving image signal is outputted by said data outputting unit;
an operation unit for inputting an operation instruction therethrough; and
a receiving control unit for generating an operation request in accordance with said operation instruction inputted by said operation unit, controlling said receiving line connection control unit in accordance with said operation request and said one or more transmission data portions transmitted by said respective one or more image transmission apparatus.

36. An image transmission apparatus as set forth in claim 34 further including:
a sound collecting unit for collecting sounds to be converted into sound signals; and
a sound inputting unit for inputting said sound signals converted by said sound collecting unit;
said compressing and encoding unit is operative to compress and encode said synthesized moving image signal synthesized by said image synthesizing unit and said sound signals inputted by said sound inputting unit to generate coded moving image signal data and coded sound signal data;
said one or more data transmitting units are operative to input said coded moving image signal data and said coded sound data generated by said compressing and encoding unit, to generate address information about said one or more image receiving apparatus to which said coded moving image signal data and said coded sound signal data are directed, and to attach said address information about said one or more image receiving apparatus to said coded moving image signal data and said coded sound data to generate one or more transmission data portions directed to said respective one or more image receiving apparatus.

37. An image receiving apparatus as set forth in claim 35 in which
said one or more data receiving units are operative to receive said one or more transmission data portions to reconstruct said coded moving image signal data and said coded sound signal data;
said one or more decompressing and decoding units are operative to decompress and decode said coded moving image signal data and said coded sound signal data reconstructed by said one or more data receiving units to reconstruct one or more synthesized moving image signals and sound signals;
said image synthesizing unit is operative to pass through said moving image signal or said synthesized moving image signal when one moving image signal or one synthesized moving image signal is reconstructed by said one or more decompressing and decoding units, and to synthesize more than one moving image signal or synthesized moving image signal to generate a synthesized moving image signal when more than one moving image signal or synthesized moving image signal is reconstructed by said one or more decompressing and decoding units, and to pass through said sound signals decompressed and decoded by said one or more decompressing and decoding units
said data outputting unit is operative to output said moving image signal passed through by said image synthesizing unit when said image synthesizing unit passes through said moving image signal, and to output said synthesized moving image signal synthesized by said image synthesizing unit when said image synthesizing unit generates said synthesized moving image signal, and to output said sound signals passed through by said image synthesizing unit; and
said monitoring unit is further provided with a speaker and operative to display one moving picture on said screen when said moving image signal is outputted by said data outputting unit, and to display a plurality of moving pictures on said screen when said synthesized moving image signal is outputted by said data outputting unit, and to audibly output said sound signals outputted by said data outputting unit.

38. An image transmission apparatus as set forth in claim 34, in which said respective one of said one or more data transmitting units is operative to generate one or more transmission data portions directed to image receiving apparatus at an input bit rate at which image receiving apparatus can receive said one or more data portions.

39. Image transmission apparatus as set forth in claim 34 further including a recording unit for temporally storing said coded moving image signal data and coded sound signal data generated by said compressing and encoding unit together with time information indicative of the time at which said coded moving image signal data arrives at said recording unit, event information indicative of the event type of said coded moving image signal data, and number information indicative of the number of said coded moving image signal data so that said coded moving image signal data and coded sound signal data are associated with said time information, said event information and said number information, said transmission control unit is operative to control said recording unit in accordance with said line connection state information generated by said transmission line connection control unit with reference to said time information, said event information, and said number information.

40. An image receiving apparatus as set forth in claim 35 further including a recording unit for temporally inputting said coded moving image signal data and said coded sound signal data reconstructed by said one or more data receiving units, and storing said coded moving image signal data and said coded sound signal data in association with time information including a time at which said coded moving image signal data arrives at said recording unit, event information including an event type of said coded moving image signal data, and number information including a number of said coded moving image signal data in accordance with said operation instruction inputted by said operation unit.

41. An image receiving apparatus as set forth in claim 40, in which said recording unit is operative to search said target coded moving image signal data and coded sound signal data from among said coded moving image signal data and coded sound signal data stored in said recording unit in accordance with said searching operation request including said key information by comparing said time information, said event information, and said number information associated with said coded moving image signal data and coded sound signal data with said key information to identify said target coded moving image signal data and coded sound signal data associated with at least one of said time information, said event information and said number information identical with said at least one of said time information, and to output said target coded moving image signal data and coded sound signal data.

42. An image transmitting and receiving method comprising the steps of: a preparing step of preparing:
a plurality of data transmission means each for transmitting one or more transmission data portions each generated as a result of compressing and encoding one or more moving image signals taken by respective camera units; and
one or more data receiving means each for receiving said one or more transmission data portions transmitted by said data transmission means through a network,
said data transmission means each including:
a plurality of camera units each for taking a moving picture of an object;
an image inputting unit operatively connected with said camera units for operating one or more said camera units to input one or more moving pictures taken by said one or more camera units to be converted to one or more moving image signals;
an image synthesizing unit for passing through said moving image signal when one moving image signal is converted by said image inputting unit and synthesizing more than one moving image signal to generate a synthesized moving image signal when more than one moving image signal is converted by said image inputting unit;
a compressing and encoding unit for compressing and encoding said moving image signal passed through by said image synthesizing unit when said image synthesizing unit passes through one moving image signal and compressing and encoding said synthesized moving image signal generated by said image synthesizing unit when said image synthesizing unit synthesizes more than one moving image signal to generate coded moving image signal data;
one or more data transmitting units for inputting said coded moving image signal data generated by said compressing and encoding unit, generating address information about said one or more data receiving means to which said coded moving image signal data is directed, and attaching address information about said one or more data receiving means to said coded moving image signal data to generate one or more transmission data portions directed to said respective one or more data receiving means;
a transmission line connection control unit for inputting said one or more transmission data portions generated by said one or more data transmitting units, establishing and maintaining one or more line connections between said one or more data transmitting units and respective one or more data receiving means in accordance with said address information attached in said one or more transmission data portions so as to transmit said one or more transmission data portions through said network to said respective one or more data receiving means, and generating line connection state information; and
a transmission control unit for controlling said image inputting unit, said image synthesizing unit, and said transmission line connection control unit in accordance with said line connection state information generated by said transmission line connection control unit;
said data receiving means each including:
a receiving line connection control unit for receiving said one or more transmission data portions transmitted by said respective one or more data transmission means;
one or more data receiving units for receiving said one or more transmission data portions to reconstruct coded moving image signal data, said receiving line connection control unit operative to establish and maintain one or more line connections between said one or more data receiving units and said respective one or more data transmission means in accordance with said address information attached in said one or more transmission data portions so as to receive said one or more transmission data portions through said network from said respective one or more data transmission means;
one or more decompressing and decoding units electrically connected with said respective one or more data receiving units in one-to-one relationship for decompressing and decoding said coded moving image signal data reconstructed by said respective one or more data receiving units to reconstruct one or more moving image signals or synthesized moving image signals;
an image synthesizing unit for passing through said moving image signal or said synthesized moving image signal when one moving image signal or one synthesized moving image signal is reconstructed by said one or more decompressing and decoding units and synthesizing more than one moving image signal or synthesized moving image signal to generate a synthesized moving image signal when more than one moving image signal or synthesized moving image signal is reconstructed by said one or more decompressing and decoding units;
a data outputting unit for outputting said moving image signal or said synthesized moving image signal passed through by said image synthesizing unit when said image synthesizing unit passes through said moving image signal or said synthesized moving image signal, and outputting said synthesized moving image signal synthesized by said image synthesizing unit when said image synthesizing unit generates said synthesized moving image signal;
a monitoring unit having a screen for displaying one moving picture on said screen when said moving image signal is outputted by said data outputting unit, and displaying a plurality of moving pictures on said screen when said synthesized moving image signal is outputted by said data outputting unit;
an operation unit for inputting an operation instruction therethrough; and
a receiving control unit for generating an operation request in accordance with said operation instruction inputted by said operation unit, and controlling said receiving line connection control unit in accordance with said operation request and said one or more transmission data portions transmitted by said respective one or more data transmission means,
a receiving control step of having said receiving control unit generate an operation request in accordance with said operation instruction inputted by said operation unit, and control said receiving line connection control unit in accordance with said operation request and said one or more transmission data portions transmitted by said respective one or more data transmission means.

43. An image transmitting and receiving method as set forth in claim 42, in which said preparing step is of further preparing: a sound collecting unit for collecting sounds to be converted into sound signals; and a sound inputting unit for inputting said sound signals converted by said sound collecting unit, for said data transmission means;
said compressing and encoding unit is operative to compress and encode said synthesized moving image signal synthesized by said image synthesizing unit and said sound signals inputted by said sound inputting unit to generate coded moving image signal data and coded sound signal data;
said one or more data transmitting units are operative to input said coded moving image signal data and said coded sound data generated by said compressing and encoding unit, to generate address information about said one or more data receiving means to which said coded moving image signal data and said coded sound signal data are directed, and to attach said address information about said one or more data receiving means to said coded moving image signal data and said coded sound data to generate one or more transmission data portions directed to said respective one or more data receiving means,
said one or more data receiving units are operative to receive said one or more transmission data portions to reconstruct said coded moving image signal data and said coded sound signal data;
said one or more decompressing and decoding units are operative to decompress and decode said coded moving image signal data and said coded sound signal data reconstructed by said one or more data receiving units to reconstruct one or more synthesized moving image signals and sound signals;
said image synthesizing unit is operative to pass through said moving image signal or said synthesized moving image signal when one moving image signal or one synthesized moving image signal is reconstructed by said one or more decompressing and decoding units, and to synthesize more than one moving image signal or synthesized moving image signal to generate a synthesized moving image signal when more than one moving image signal or synthesized moving image signal is reconstructed by said one or more decompressing and decoding units, and to pass through said sound signals decompressed and decoded by said one or more decompressing and decoding units,
said data outputting unit is operative to output said moving image signal passed through by said image synthesizing unit when said image synthesizing unit passes through said moving image signal, and to output said synthesized moving image signal synthesized by said image synthesizing unit when said image synthesizing unit generates said synthesized moving image signal, and to output said sound signals passed through by said image synthesizing unit; and
said monitoring unit is further provided with a speaker and operative to display one moving picture on said screen when said moving image signal is outputted by said data outputting unit, and to display a plurality of moving pictures on said screen when said synthesized moving image signal is outputted by said data outputting unit, and to audibly output said sound signals outputted by said data outputting unit, and which further comprises a sound inputting step of having sound inputting unit input said sound signals converted by said sound collecting unit, for said data transmission means;

44. An image transmitting and receiving method as set forth in claim 43, in which said camera unit includes a camera portion positioned at a predetermined position and provided with a charged coupled device for taking a moving picture at a predetermined shutter speed, a driving unit for having said camera portion moved horizontally and vertically, and an image processing circuit for converting said moving picture into moving image signal.

45. An image transmitting and receiving method as set forth in claim 44, in which one of said camera units is operative to take a moving picture of a respective object at a time, said image inputting unit includes a camera switching circuit for switching one of said camera units operative to take a moving picture to another camera unit operative to take another moving picture at a predetermined interval in a predetermined order, an analog to digital converter for converting said moving picture taken by said camera unit into said moving image signal, and a memory buffer for temporally storing said moving image signal, and said transmission control unit is operative to control said image inputting unit in accordance with said line connection state information so as to input one moving picture taken by one camera unit to be converted to one moving image signal or more than one moving picture taken by more than one camera unit to be converted to more than one moving image signal.

46. An image transmitting and receiving method as set forth in claim 43, in which said address information includes addresses of more than one data receiving means, and one of said one or more data transmitting units is operative to attach said address information about said more than one data receiving means to said coded moving image signal data generated by said compressing and encoding unit to generate one or more transmission data portion each directed to said more than one data receiving means, said transmission line connection control unit is operative to input said one or more transmission data portions generated by said one of said one or more data transmitting units, establishing and maintaining one or more line connections between said one of said one or more data transmitting units and respective one or more data receiving means in accordance with said address information attached in said one or more transmission data portions so as to transmit said one or more transmission data portions through said network to said respective one or more data receiving means.

47. An image transmitting and receiving method as set forth in claim 46, in which said operation unit is operative to input an operation instruction for specifying one data transmission means to establish and maintain a line connection with, and controlling said image inputting unit of said specified data transmission means to operate specified one or more camera units of said one or more camera units to input one or more moving pictures, said receiving control unit is operative to generate an operation request in accordance with said operation instruction inputted by said operation unit, said receiving line connection control unit is operative to receive said operation request generated by said receiving control unit, to identify said specified data transmission means, to establish and maintain a line connection between said specified data transmission means and one of said data receiving units in accordance with said operation request, and to transmit said operation request through said network to said specified data transmission means, said transmission line connection control unit of said specified data transmission means is operative to generate said line connection state information in accordance with said operation request transmitted by said receiving line connection control unit of said data receiving means, said transmission control unit is operative to input said line connection state information generated by said transmission line connection control unit, and to control said transmission line connection control unit in accordance with said line connection state information so as to maintain a line connection between said data receiving means and said data transmission means, said transmission control unit is further operative to control said image inputting unit in accordance with said line connection state information so that said image inputting unit operate said specified one or more camera units of said one or more camera units to input one or more moving pictures to be converted to one or more moving image signals, and said transmission control unit is further operative to control said image synthesizing unit in accordance with said line connection state information so that said image synthesizing unit passes through said moving image signal when one moving image signal is converted by said image inputting unit and synthesizes more than one moving image signal to generate a synthesized moving image signal when more than one moving image signal is converted by said image inputting unit.

48. An image transmitting and receiving method as set forth in claim 47, in which said operation unit is operative to input an operation instruction for specifying one data transmission means to establish and maintain a line connection with, and specifying positions of specified one or more camera units of said one or more camera units operatively connected with said image inputting unit of specified data transmission means, said receiving control unit is operative to generate an operation request in accordance with said operation instruction inputted by said operation unit, said receiving line connection control unit is operative to receive said operation request generated by said receiving control unit, to identify said specified data transmission means, to establish and maintain a line connection between said specified data transmission means and one of said data receiving units in accordance with said operation request, and to transmit said operation request through said network to said specified data transmission means, and said transmission control unit is operative to control said image inputting unit in accordance with said line connection state information so that said image inputting unit operates said specified one or more camera units of said one or more camera units to drive one or more driving units of said specified one or more camera units of said one or more camera units to have said camera portions of said specified one or more camera units of said one or more camera units moved horizontally and vertically to said respective specified positions.

49. An image transmitting and receiving method as set forth in claim 47, in which said operation unit is operative to input a switching operation instruction for switching said data transmission means to another data transmission means while said data transmission means maintains a line connection between said data transmission means and one of said data receiving units of said data receiving means, said receiving control unit is operative to generate a switching operation request in accordance with said switching operation instruction inputted by said operation unit, said receiving line connection control unit is operative to receive said switching operation request generated by said receiving control unit, to disconnect a line connection between said data transmission means and the respective one of the data receiving units if required, to identify said another data transmission means, to establish and maintain another line connection between said another data transmission means and another one of said data receiving units in accordance with said switching operation request, and to transmit said operation request through said network to said another data transmission means, said transmission line connection control unit of said another data transmission means is operative to generate said line connection state information in accordance with said switching operation request transmitted by said receiving line connection control unit of said data receiving means, and said transmission control unit is operative to input said line connection state information generated by said transmission line connection control unit, and to control said transmission line connection control unit in accordance with said line connection state information so as to maintain a line connection between said data receiving means and said data transmission means.

50. An image transmitting and receiving method as set forth in claim 49, in which said preparing step is of further preparing a configuration control unit having a configuration storage portion for inputting configuration conditions to be stored therein, for said data receiving means, said configuration conditions include a time interval for which one data transmission means is switched to another data transmission means, and a switching order in which said data transmission means is switched, and said receiving control unit is operative to generate a regular switching operation request at said time interval in said switching order in accordance with said configuration conditions stored in said configuration control unit, which further comprises a configuration control step of having said configuration control unit input configuration conditions to be stored therein, for said data receiving means.

51. An image transmitting and receiving method as set forth in claim 42, in which said preparing step is of further preparing a configuration control unit having a configuration storage portion for inputting configuration conditions to be stored therein, for said data receiving means, said configuration conditions include information about one-to-one relationship between said one or more data receiving units and said one or more data transmission means, said receiving control unit is operative to generate a receiving operation request in accordance with said configuration conditions stored in said configuration control unit, said receiving line connection control unit is operative to receive said receiving operation request generated by said receiving control unit, to identify said specified one or more data transmission means, to establish and maintain line connections between said specified data transmission means and said one or more data receiving units each corresponding to respective one or more data transmission means in one-to-one relationship in accordance with said receiving operation request, and to transmit said operation request through said network to said specified data transmission means, said transmission line connection control unit of said specified data transmission means is operative to generate said line connection state information in accordance with said receiving operation request transmitted by said receiving line connection control unit of said data receiving means, and said transmission control unit is operative to input said line connection state information generated by said transmission line connection control unit, and to control said transmission line connection control unit in accordance with said line connection state information so as to maintain line connections between said data receiving means and said respective one or more data receiving units, which further comprises a configuration control step of having said configuration control unit input configuration conditions to be stored therein, for said data receiving means.

52. An image transmitting and receiving method as set forth in claim 51, in which said one or more data receiving means are operative to receive said one or more transmission data portions at respective input bit rates, said configuration conditions include information about said input bit rate, said receiving control unit of said data receiving means is operative to generate a receiving operation request in accordance with said configuration conditions stored in said configuration control unit, said receiving line connection control unit is operative to receive said receiving operation request generated by said receiving control unit, to establish and maintain line connections between said specified data transmission means and said data receiving means, and to transmit said receiving operation request through said network to said specified data transmission means, said transmission line connection control unit is operative to generate said line connection state information in accordance with said operation request transmitted by the receiving line connection control unit, and said respective one of said one or more data transmitting units is operative to generate one or more transmission data portions directed to said data receiving means at said input bit rate.

53. An image transmitting and receiving method as set forth in claim 42, in which said data receiving means is operative to receive one or more transmission data portions transmitted by another data transmission means, and said receiving line connection control unit of said data receiving means is operative to establish and maintain another line connection between another one of said data receiving units and said another data transmission means in response to said one or more transmission data portions transmitted by another data transmission means, while said data receiving means maintains a line connection between said data receiving means and one data transmission means, and said receiving line connection control unit maintains a line connection between one of said data receiving units and said data transmission means.

54. An image transmitting and receiving method as set forth in claim 42, in which while said data transmission means maintains a line connection between said data receiving means and said data transmission means, and said transmission line connection control unit maintains a line connection between one of said data transmitting units and said data receiving means so as to transmit said one or more transmission data portions generated by said one of said data transmitting units to said data receiving means, said data transmission means is operative to transmit one or more transmission data portions to another data receiving means, said transmission line connection control unit of said data transmission means is operative to establish and maintain another line connection between said another data receiving means and another one of said data transmitting units so as to transmit said one or more transmission data portions to said another data receiving means, and said receiving line connection control unit of said another data receiving means is operative to establish and maintain said line connection between one of said data receiving units and said data transmission means to receive said one or more transmission data portions transmitted by said data transmission means.

55. An image transmitting and receiving method as set forth in claim 42, in which when a line connection between data transmission means and data receiving means is disconnected while one of said data transmitting units is transmitting one or more transmission data portions through said network to said data receiving means, said transmission line connection control unit is operative to restore and maintain said line connection between one of said data transmitting units and said data receiving means so as to transmit said one or more transmission data portions generated by said one of said data transmitting units through said network to said data receiving means, said receiving line connection control unit is operative to restore and maintain said line connection between one of said data receiving units and said data transmission means to receive said one or more transmission data portions transmitted by said data transmission means.

56. An image transmitting and receiving method as set forth in claim 42, in which said compressing and encoding unit is operative to compress and encode said moving image signal passed through by said image synthesizing unit when one moving image signal is converted by said image inputting unit and said synthesized moving image signal generated by said image synthesizing unit when more than one moving image signal is converted by said image inputting unit in conformance with the ITU-T Recommendation H.261 standard or ITU-T Recommendation H.263 standard to generate coded moving image signal data, and said one or more decompressing and decoding units are operative to decompress and decode said coded moving image signal data reconstructed by said one or more data receiving units in conformance with the ITU-T Recommendation H.261 standard or ITU-T Recommendation H.263 standard to reconstruct one or more moving image signals.

57. An image transmitting and receiving method as set forth in claim 42, in which said compressing and encoding unit is operative to compress and encode said moving image signal passed through by said image synthesizing unit when one moving image signal is converted by said image inputting unit and said synthesized moving image signal generated by said image synthesizing unit when more than one moving image signal is converted by said image inputting unit in conformance with the MPEG-1, MPEG-2 or MPEG-3 standard to generate coded moving image signal data, and said one or more decompressing and decoding units are operative to decompress and decode said coded moving image signal data reconstructed by said one or more data receiving units in conformance with the MPEG-1, MPEG-2, or MPEG-3 standard to reconstruct one or more moving image signals.

58. An image transmitting and receiving method as set forth in claim 42, in which said compressing and encoding unit is operative to compress and encode said moving image signal passed through by said image synthesizing unit when one moving image signal is converted by said image inputting unit and said synthesized moving image signal generated by said image synthesizing unit when more than one moving image signal is converted by said image inputting unit in conformance with the JPEG or JPEG2000 standard to generate coded moving image signal data, and said one or more decompressing and decoding units is operative to decompress and decode said coded moving image signal data reconstructed by said one or more data receiving units in conformance with the JPEG or JPEG2000 standard to reconstruct one or more moving image signals.

59. An image transmitting and receiving method as set forth in claim 43, in which said preparing step is of further preparing a recording unit for temporally storing said coded moving image signal data and coded sound signal data generated by said compressing and encoding unit together with time information indicative of the time at which said coded moving image signal data arrives at said recording unit, event information indicative of the event type of said coded moving image signal data, and number information indicative of the number of said coded moving image signal data so that said coded moving image signal data and coded sound signal data are associated with said time information, said event information and said number information, for said data transmission means, said transmission control unit is operative to control said recording unit in accordance with said line connection state information generated by said transmission line connection control unit with reference to said time information, said event information, and said number information, which further comprises a recording step of having said recording unit temporally store said coded moving image signal data and coded sound signal data together with time information, event information, and number information so that said coded moving image signal data and coded sound signal data are associated with said time information, said event information and said number information, for said data transmission means.

60. An image transmitting and receiving method as set forth in claim 43, in which said preparing step is of further preparing a recording unit for temporally inputting said coded moving image signal data and said coded sound signal data reconstructed by said one or more data receiving units, and storing said coded moving image signal data and said coded sound signal data in association with time information including a time at which said coded moving image signal data arrives at said recording unit, event information including an event type of said coded moving image signal data, and number information including a number of said coded moving image signal data in accordance with said operation instruction inputted by said operation unit, for said data receiving means, which further comprises a recording step of said recording unit temporally input and store said coded moving image signal data and said coded sound signal data in association with time information, event information, and number information in accordance with said operation instruction inputted by said operation unit, for said data receiving means.

61. An image transmitting and receiving method as set forth in claim 60, in which said operation unit is operative to input a synthesizing operation instruction for synthesizing specified moving image signals or synthesized moving image signals for said image synthesizing unit, said receiving control unit is operative to generate a synthesizing operation request in accordance with said synthesizing operation instruction inputted by said operation unit, and said image synthesizing unit is operative to select specified moving image signals or synthesized moving image signals from among said moving image signals or synthesized moving image signals reconstructed by said one or more decompressing and decoding units in accordance with said synthesizing operation request generated by said receiving control unit and synthesizing said specified moving image signal or synthesized moving image signal to generate a synthesized moving image signal when said moving image signals or synthesized moving image signals are reconstructed by said one or more decompressing and decoding units.

62. An image transmitting and receiving method as set forth in claim 61, in which said operation unit is operative to input a reproducing operation instruction for controlling said recording unit to output said coded moving image signal data and said coded sound signal data stored therein, said receiving control unit is operative to generate a reproducing operation request in accordance with said reproducing operation instruction inputted by said operation unit, said recording unit is operative to output said coded moving image signal data and coded sound signal data stored therein in accordance with said reproducing operation request generated by said receiving control unit, and said one or more decompressing and decoding units are operative to decompress and decode said coded moving image signal data and said coded sound signal data outputted by said recording unit to reconstruct one or more synthesized moving image signals and sound signals.

63. An image transmitting and receiving method as set forth in claim 62, in which said operation unit is operative to input a searching operation instruction for searching a target coded moving image signal data and coded sound signal data with a key information containing at least one of said time information, said event information and said number information, said receiving control unit is operative to generate a searching operation request in accordance with said searching operation instruction inputted by said operation unit, and said recording unit is operative to search said target coded moving image signal data and coded sound signal data from among said coded moving image signal data and coded sound signal data stored in said recording unit in accordance with said searching operation request including said key information by comparing said time information, said event information, and said number information associated with said coded moving image signal data and coded sound signal data with said key information to identify said target coded moving image signal data and coded sound signal data associated with at least one of said time information, said event information and said number information identical with said at least one of said time information, and to output said target coded moving image signal data and coded sound signal data.

64. An image transmitting and receiving method as set forth in claim 63, in which said preparing step is of further preparing an external appliance unit for outputting a status control signal indicative of the state of said external appliance unit, and an appliance control data communication unit for transmitting said status control signal outputted by said external appliance unit to said transmission line connection control unit of said data receiving means through said network while said line connection between said data transmission means and said data receiving means is established and maintained, for said data transmission means, and said external appliance control data communication unit is operative to generate and transmit appliance control signal to the external appliance unit in accordance with a line connection state information generated by said transmission line connection control unit, and said external appliance unit is operative to operate in accordance with said respective appliance control signal generated by said appliance control data communication unit, which further comprises an appliance control data communication step of having said appliance control data communication unit transmit said status control signal to said transmission line connection control unit of said data receiving means through said network.

65. An image transmitting and receiving method as set forth in claim 64, in which said data transmission means includes a plurality of external appliance units for respectively outputting a plurality of status control signals each indicative of the state of said external appliance unit, said appliance control data communication unit is operative to transmit said status control signals respectively outputted by said external appliance units to said transmission line connection control unit, and to receive said line connection state information generated by said transmission line connection control unit to generate a plurality of appliance control signals, and said external appliance units being operative to respectively operate in accordance with said appliance control signals generated by said appliance control data communication unit.

66. An image transmitting and receiving method as set forth in claim 65, in which said preparing step is of further preparing an external appliance control unit for inputting an external appliance operation instruction for operating specified one or more external appliance units of said data transmission means to generate an external appliance operation request, for said data receiving means, said receiving line connection control unit is operative to transmit said external appliance operation request generated by said external appliance control unit through said network to said data transmission means when said receiving line connection control unit maintains said line connection between said data receiving means and said data transmission means, said transmission line connection control unit of said data transmission means is operative to receive said external appliance operation request, and to generate a line connection state information in accordance with said external appliance operation request thus received, and said appliance control data communication unit is operative to receive said line connection state information generated by said transmission line connection control unit to generate one or more appliance control signals, said specified one or more external appliance units are operative to respectively operate in accordance with said one or more appliance control signals generated by said appliance control data communication unit, which further comprises an external appliance control step of having said external appliance control unit input an external appliance operation instruction for operating specified one or more external appliance units of said data transmission means to generate an external appliance operation request, for said data receiving means.

67. An image transmitting and receiving method as set forth in claim 66, in which said external appliance control unit is operative to input an appliance status indicating instruction for displaying the status of specified one or more external appliance units, said one or more external appliance units are operative to respectively output one or more status control signals each indicative of the state of said external appliance unit including the type of said external appliance, said appliance control data communication unit is operative to transmit said one or more status control signals respectively outputted by said one or more external appliance units to said transmission line connection control unit, said transmission line connection control unit is operative to transmit said one or more status control signals through said network to said data receiving means when said transmission line connection control unit maintains said line connection between data transmission means and said data receiving means, said receiving line connection control unit of said data receiving means is operative to receive said one or more status control signals, and said external appliance control unit is operative to input said one or more status control signals received by said receiving line connection control unit, and to indicate the status of said specified one or more external appliance units in accordance with said appliance status indicating instruction for displaying the status of specified one or more external appliance units.

68. An image transmitting and receiving method as set forth in claim 67, in which said external appliance control unit is operated to input an appliance status displaying instruction for displaying the status of specified one or more external appliance units and output said appliance status displaying instruction to said monitoring unit, and said monitoring unit is operative to input said one or more status control signals respectively indicative of the status of said one or more external appliance units received by said receiving line connection control unit, and to display the status of said specified one or more external appliance units from among sad one or more external appliance units in accordance with said appliance status displaying instruction outputted by said external appliance control unit when said receiving line connection control unit maintains said line connection between said data receiving means and said data transmission means.

69. An image transmitting and receiving method as set forth in claim 68, in which said external appliance control unit is operative to input an external appliance operation instruction for operating specified one or more external appliance units when said monitoring unit displays the status of said specified one or more external appliance units while said receiving line connection control unit maintains said line connection between said data receiving means and said data transmission means.

70. An image transmitting and receiving method as set forth in claim 69, in which said monitoring unit is operative to display said one or more moving pictures and the status of said specified one or more external appliance units on said screen at the same time.

71. An image transmitting and receiving method as set forth in claim 70, in which said external appliance control unit is operative to input an external appliance operation instruction for operating specified one or more external appliance units when said monitoring unit displays said one or more moving pictures and the status of said specified one or more external appliance units while said receiving line connection control unit maintains said line connection between said data receiving means and said data transmission means.

72. An image transmitting and receiving method as set forth in claim 70, in which said image inputting unit of said data transmission means is operative to generate camera status information indicative of the status of said camera unit, said operation unit is operative to input a camera status display instruction for displaying the status of specified camera unit of specified data transmission means, said receiving control unit is operative to generate a camera status display operation request in accordance with said camera status display instruction inputted by said operation unit, said receiving line connection control unit is operative to transmit said camera status display operation request generated by said receiving control unit to said specified data transmission means while said receiving line connection control unit maintains said line connection between said data receiving means and said specified data transmission means, said transmission line connection unit is operative to receive said camera status display operation request to be outputted to said image inputting unit of said specified camera unit, said image inputting unit is operative to generate said camera status information indicative of the status of said specified camera unit from said camera units in accordance with said camera status display operation request outputted by said transmission line connection unit, and said transmission line connection unit is operative to transmit said camera status information to said receiving line connection control unit, and said monitoring unit is operative to display said status of said specified camera unit of said specified data transmission means in accordance with said camera status information.

73. An image transmitting and receiving method as set forth in claim 72, in which said camera unit further includes a rotatable plate on which said camera portion is mounted, said rotatable plate is electrically connected with said image inputting unit, said transmission control unit is operative to control said image inputting unit so as to rotate said camera portion to any one of a plurality of camera angles of camera units in association with respective camera unit position numbers, said image inputting unit includes a storage portion for storing said camera angles of a specified camera unit and camera unit position numbers, the status of said camera unit includes all of camera angles of camera units and said camera unit position numbers, whereby said operation unit is operative to input a camera unit position number of a specified data transmission means and a camera angle number storing instruction for storing said camera angle of said specified camera unit so as to store the present camera angle of said specified camera unit of said specified data transmission means in association with said camera unit position number thus inputted, said receiving control unit is operative to generate a camera angle number storing operation request in accordance with said camera angle number storing instruction inputted by said operation unit, said receiving line connection control unit is operative to transmit said camera angle number storing operation request generated by said receiving control unit to said specified data transmission means while said receiving line connection control unit maintains said line connection between said data receiving means and said specified data transmission means, said transmission line connection unit is operative to receive said camera angle number storing operation request to be outputted to said image inputting unit of said specified camera unit, and said image inputting unit is operative to store the present camera angle of said specified data transmission means in association with said camera unit position number thus inputted in accordance with said camera angle number storing operation request outputted by said transmission line connection unit.

74. An image transmitting and receiving method as set forth in claim 73, in which said operation unit is operative to input a camera unit position number of a specified data transmission means and a camera angle number operation instruction for moving said camera angle of said specified data transmission means to said camera angle in association with sad camera unit position number thus inputted, said receiving control unit is operative to generate a camera angle number operation request in accordance with said camera angle number operation instruction inputted by said operation unit, and said transmission control unit is operative to control said image inputting unit so as to rotate said camera portion of said specified camera unit to said camera angle in association with said camera unit position umber inputted by said operation unit.

75. An image transmitting method of transmitting one or more transmission data portions each generated as a result of compressing and encoding one or more moving image signals taken by respective camera units, comprising the steps of:
a preparing step of preparing:
a plurality of camera units each for taking a moving picture of an object;
an image inputting unit operatively connected with said camera units for operating one or more said camera units to input one or more moving pictures taken by said one or more camera units to be converted to one or more moving image signals;
an image synthesizing unit for passing through said moving image signal when one moving image signal is converted by said image inputting unit and synthesizing more than one moving image signal to generate a synthesized moving image signal when more than one moving image signal is converted by said image inputting unit;
a compressing and encoding unit for compressing and encoding said moving image signal passed through by said image synthesizing unit when said image synthesizing unit passes through one moving image signal and compressing and encoding said synthesized moving image signal generated by said image synthesizing unit when said image synthesizing unit synthesizes more than one moving image signal to generate coded moving image signal data;
one or more data transmitting units for inputting said coded moving image signal data generated by said compressing and encoding unit, generating address information about one or more image receiving apparatus to which said coded moving image signal data is directed, and attaching address information about said one or more image receiving apparatus to said coded moving image signal data to generate one or more transmission data portions directed to said respective one or more image receiving apparatus;
a transmission line connection control unit for inputting said one or more transmission data portions generated by said one or more data transmitting units, establishing and maintaining one or more line connections between said one or more data transmitting units and respective one or more image receiving apparatus in accordance with said address information attached in said one or more transmission data portions so as to transmit said one or more transmission data portions through said network to said respective one or more image receiving apparatus, and generating line connection state information; and
a transmission control unit for controlling said image inputting unit, said image synthesizing unit, and said transmission line connection control unit in accordance with said line connection state information generated by said transmission line connection control unit;
a transmission control step of having said transmission control unit control said image inputting unit, said image synthesizing unit, and said transmission line connection control unit in accordance with said line connection state information generated by said transmission line connection control unit.

76. An image receiving method for receiving said one or more transmission data portions transmitted by one or more image transmission apparatus through a network comprising the steps of:
a preparing step of preparing:
a receiving line connection control unit for receiving said one or more transmission data portions transmitted by said respective one or more image transmission apparatus;
one or more data receiving units for receiving said one or more transmission data portions to reconstruct coded moving image signal data, said receiving line connection control unit operative to establish and maintain one or more line connections between said one or more data receiving units and said respective one or more image transmission apparatus in accordance with said address information attached in said one or more transmission data portions so as to receive said one or more transmission data portions through said network from said respective one or more image transmission apparatus;
one or more decompressing and decoding units electrically connected with said respective one or more data receiving units in one-to-one relationship for decompressing and decoding said coded moving image signal data reconstructed by said respective one or more data receiving units to reconstruct one or more moving image signals or synthesized moving image signals;
an image synthesizing unit for passing through said moving image signal or said synthesized moving image signal when one moving image signal or one synthesized moving image signal is reconstructed by said one or more decompressing and decoding units and synthesizing more than one moving image signal or synthesized moving image signal to generate a synthesized moving image signal when more than one moving image signal or synthesized moving image signal is reconstructed by said one or more decompressing and decoding units;
a data outputting unit for outputting said moving image signal or said synthesized moving image signal passed through by said image synthesizing unit when said image synthesizing unit passes through said moving image signal or said synthesized moving image signal, and outputting said synthesized moving image signal synthesized by said image synthesizing unit when said image synthesizing unit generates said synthesized moving image signal;
a monitoring unit having a screen for displaying one moving picture on said screen when said moving image signal is outputted by said data outputting unit, and displaying a plurality of moving pictures on said screen when said synthesized moving image signal is outputted by said data outputting unit; an operation unit for inputting an operation instruction therethrough; and a receiving control unit for generating an operation request in accordance with said operation instruction inputted by said operation unit, controlling said receiving line connection control unit in accordance with said operation request and said one or more transmission data portions transmitted by said respective one or more image transmission apparatus,
a receiving control step of having said receiving control unit generate an operation request in accordance with said operation instruction inputted by said operation unit, controlling said receiving line connection control unit in accordance with said operation request and said one or more transmission data portions transmitted by said respective one or more image transmission apparatus.

77. An image transmitting method as set forth in claim 75, in which said preparing step is of further preparing a sound collecting unit for collecting sounds to be converted into sound signals; and a sound inputting unit for inputting said sound signals converted by said sound collecting unit; said compressing and encoding unit is operative to compress and encode said synthesized moving image signal synthesized by said image synthesizing unit and said sound signals inputted by said sound inputting unit to generate coded moving image signal data and coded sound signal data; said one or more data transmitting units are operative to input said coded moving image signal data and said coded sound data generated by said compressing and encoding unit, to generate address information about said one or more image receiving apparatus to which said coded moving image signal data and said coded sound signal data are directed, and to attach said address information about said one or more image receiving apparatus to said coded moving image signal data and said coded sound data to generate one or more transmission data portions directed to said respective one or more image receiving apparatus, and which further comprises a sound inputting step of having said sound inputting unit input said sound signals converted by said sound collecting unit.

78. An image receiving method as set forth in claim 76 in which
said one or more data receiving units are operative to receive said one or more transmission data portions to reconstruct said coded moving image signal data and said coded sound signal data;
said one or more decompressing and decoding units are operative to decompress and decode said coded moving image signal data and said coded sound signal data reconstructed by said one or more data receiving units to reconstruct one or more synthesized moving image signals and sound signals;
said image synthesizing unit is operative to pass through said moving image signal or said synthesized moving image signal when one moving image signal or one synthesized moving image signal is reconstructed by said one or more decompressing and decoding units, and to synthesize more than one moving image signal or synthesized moving image signal to generate a synthesized moving image signal when more than one moving image signal or synthesized moving image signal is reconstructed by said one or more decompressing and decoding units, and to pass through said sound signals decompressed and decoded by said one or more decompressing and decoding units
said data outputting unit is operative to output said moving image signal passed through by said image synthesizing unit when said image synthesizing unit passes through said moving image signal, and to output said synthesized moving image signal synthesized by said image synthesizing unit when said image synthesizing unit generates said synthesized moving image signal, and to output said sound signals passed through by said image synthesizing unit; and
said monitoring unit is further provided with a speaker and operative to display one moving picture on said screen when said moving image signal is outputted by said data outputting unit, and to display a plurality of moving pictures on said screen when said synthesized moving image signal is outputted by said data outputting unit, and to audibly output said sound signals outputted by said data outputting unit.

79. An image transmission method as set forth in claim 75, in which said respective one of said one or more data transmitting units is operative to generate one or more transmission data portions directed to image receiving apparatus at an input bit rate at which image receiving apparatus can receive said one or more data portions.

80. Image transmission method as set forth in claim 75 in which said preparing step is of further preparing a recording unit for temporally storing said coded moving image signal data and coded sound signal data generated by said compressing and encoding unit together with time information indicative of the time at which said coded moving image signal data arrives at said recording unit, event information indicative of the event type of said coded moving image signal data, and number information indicative of the number of said coded moving image signal data so that said coded moving image signal data and coded sound signal data are associated with said time information, said event information and said number information, said transmission control unit is operative to control said recording unit in accordance with said line connection state information generated by said transmission line connection control unit with reference to said time information, said event information, and said number information, and which further comprises a recording step of having said recording unit temporally storing said coded moving image signal data and coded sound signal data together with time information, event information, and number information so that said coded moving image signal data and coded sound signal data are associated with said time information, said event information and said number information.

81. An image receiving method as set forth in claim 76 in which said preparing step is of further preparing a recording unit for temporally inputting said coded moving image signal data and said coded sound signal data reconstructed by said one or more data receiving units, and storing said coded moving image signal data and said coded sound signal data in association with time information including a time at which said coded moving image signal data arrives at said recording unit, event information including an event type of said coded moving image signal data, and number information including a number of said coded moving image signal data in accordance with said operation instruction inputted by said operation unit and which further comprises a recording step of having said recording unit temporally inputting and storing said coded moving image signal data and said coded sound signal data in association with time information, event information, and number information in accordance with said operation instruction inputted by said operation unit.

82. An image receiving method as set forth in claim 81, in which said recording unit is operative to search said target coded moving image signal data and coded sound signal data from among said coded moving image signal data and coded sound signal data stored in said recording unit in accordance with said searching operation request including said key information by comparing said time information, said event information, and said number information associated with said coded moving image signal data and coded sound signal data with said key information to identify said target coded moving image signal data and coded sound signal data associated with at least one of said time information, said event information and said number information identical with said at least one of said time information, and to output said target coded moving image signal data and coded sound signal data.
